(19) United States
(12) Patent Application Publication
(10) Pub. No.: US 2025/0388501 A1
(43) Pub. Date: Dec. 25, 2025

(54) COMPOSITION AND USE THEREOF

(71) Applicant: SHIKOKU CHEMICALS CORPORATION, Kagawa (JP)

(72) Inventors: Akihiro NORIMOTO, Tokushima (JP); Kumiko TAKAHASHI, Tokushima (JP); Koichi SAHIRO, Tokushima (JP); Mikio IWATA, Tokushima (JP)

(73) Assignee: SHIKOKU CHEMICALS CORPORATION, Kagawa (JP)

(21) Appl. No.: 19/309,193

(22) Filed: Aug. 25, 2025

Related U.S. Application Data
(63) Continuation of application No. PCT/JP2024/019801, filed on May 30, 2024.

(30) Foreign Application Priority Data
Jun. 9, 2023 (JP) 2023-095144

(51) Int. Cl. C02F 1/72; C02F 1/76; D21C 9/12; D21C 9/16

(52) U.S. Cl. CPC C02F 1/722; C02F 1/76; D21C 9/12; D21C 9/163; C02F 2305/02

(57) ABSTRACT

The present invention provides a solid composition comprising an oxygen-based oxidizing agent and a halogen-based oxidizing agent. The composition is not only useful for applications such as water treatment, but also exhibits excellent safety during use and excellent stability during storage. The present invention relates to a solid composition comprising a halogen-based oxidizing agent and an oxygen-based oxidizing agent, wherein the halogen-based oxidizing agent or the oxygen-based oxidizing agent, or both, are covered with a coating layer, and relates to a production method for the composition, and a method for using the composition.

### TECHNICAL FIELD

The present invention relates to a composition that can be used for, for example, treatment of a wide range of water areas, such as pools, spas, and fountains, and to a method for using the composition.

### BACKGROUND ART

A technique of combining a halogen-based oxidizing agent (e.g., a chlorine agent) and an oxygen-based oxidizing agent (e.g., a persulfate) is known as a “shock agent” that is used when water quality significantly deteriorates, such as when water turbidity or algae appear in pools.

For example, PTL 1 discloses a technique for removing volatile halogen compounds from the air and water in indoor aquatic facilities by separately adding a halogen source (containing sodium dichloroisocyanurate, which is a halogen-based oxidizing agent), a coagulant, and a peroxygen compound (containing potassium monopersulfate, which is an oxygen-based oxidizing agent) while monitoring the oxidation-reduction potential of the water area. However, the method of separately adding a halogen source and a peroxygen compound is troublesome for treatment, which is a problem.

PTL 2 discloses a solid composition useful for water treatment in circulating water systems, such as recreational, ornamental, and industrial water systems. PTL 2 discloses that the solid composition contains an oxidizing agent and an active halogen agent, wherein the oxidizing agent is potassium monopersulfate (an oxygen-based oxidizing agent), and the active halogen agent is an alkali metal salt of dichloroisocyanuric acid (a halogen-based oxidizing agent), halogenated dimethylhydantoin (a halogen-based oxidizing agent), or a mixture thereof. PTL 2 discloses that the solid composition is a safe and stable solid composition that generates less toxic chlorine gas and less heat when in contact with water.

PTL 3 discloses a solid-bleaching-agent-containing material having a coating layer and a composition comprising the material, and discloses that the composition protects the solid bleach from degradation, deactivation, and decomposition to thereby achieve stability.

### CITATION LIST

### Patent Literature

PTL 1: U.S. Pat. No. 6,409,926
PTL 2: US Patent Application Publication No. 2006/0078584
PTL 3: WO 2017/183726

### SUMMARY OF INVENTION

### Technical Problem

However, since the solid composition of PTL 2 contains an oxidizing agent (an oxygen-based oxidizing agent) and an active halogen agent (a halogen-based oxidizing agent), there are potential problems; for example, unexpected water entry during use can generate heat, causing significant deterioration in safety, and long-term storage can cause deterioration in stability.

As a result of analyzing the above points, the present inventors found that the solid composition of PTL 2, which is a mixture of an oxidizing agent and an active halogen agent, becomes dangerously hot due to heat generation upon contact with a small amount of water, causes gas generation due to side reactions during storage, causes corrosion of the storage container due to the generated gas, and causes breakage of the storage container due to corrosion. More specifically, the inventors confirmed that the solid composition of PTL 2 has problems in terms of safety and stability during use and storage.

Accordingly, an object of the present invention is to provide a composition comprising an oxygen-based oxidizing agent and a halogen-based oxidizing agent, the composition not only being useful for various applications, such as water treatment, but also having excellent safety during use and excellent stability during storage. Another object of the present invention is to provide a method for using the composition.

### Solution to Problem

The present inventors conducted extensive research to solve the above problem. As a result, the inventors found that the problem can be solved by a solid composition comprising a halogen-based oxidizing agent and an oxygen-based oxidizing agent, wherein the halogen-based oxidizing agent or the oxygen-based oxidizing agent, or both, are covered with a coating layer. As a result of further research and consideration, the present invention has been accomplished.

Specifically, the present invention provides the following composition, production method for the composition, and use of the composition (method of use).

[1] A composition comprising a halogen-based oxidizing agent and an oxygen-based oxidizing agent, wherein the halogen-based oxidizing agent or the oxygen-based oxidizing agent, or both, are covered with a coating layer.

[2] The composition according to [1], which is one composition selected from the group consisting of (1) to (3) below:

(1) a composition comprising
a halogen-based-oxidizing-agent-containing material that contains a halogen-based oxidizing agent and a coating layer on its surface, and
an oxygen-based oxidizing agent,
   (2) a composition comprising
an oxygen-based-oxidizing-agent-containing material that contains an oxygen-based oxidizing agent and a coating layer on its surface, and
a halogen-based oxidizing agent, and
   (3) a composition comprising
a halogen-based-oxidizing-agent-containing material that contains a halogen-based oxidizing agent and a coating layer on its surface, and
an oxygen-based-oxidizing-agent-containing material that contains an oxygen-based oxidizing agent and a coating layer on its surface.

[3] The composition according to [1] or [2], wherein the coating layer contains at least one member selected from the group consisting of metal salts of carboxylic acids, surfactants, polysaccharides, higher fatty acids, paraffin waxes, zeolites, and resins.

[4] The composition according to [3], wherein the coating layer contains a metal salt of a carboxylic acid, and the metal salt of a carboxylic acid is at least one member selected from the group consisting of alkali metal salts of aromatic carboxylic acids, alkali metal salts of acyclic dicarboxylic acids, alkali metal salts of acyclic monocarboxylic acids, and mixtures thereof.

[5] The composition according to any one of [1] to [4], wherein the composition further comprises a coagulant (in particular, a cationic polymer coagulant having a quaternary ammonium salt).

[6] The composition according to any one of [1] to [5], wherein the composition is a composition comprising a halogen-based-oxidizing-agent-containing material that contains a halogen-based oxidizing agent and a coating layer on its surface, and an oxygen-based oxidizing agent (the composition (1) in [2]).

[7] The composition according to [6], wherein the content of the halogen-based-oxidizing-agent-containing material in the composition is 5 wt % or more and 95 wt % or less.

[8] The composition according to [6] or [7], wherein the content of the halogen-based oxidizing agent in the halogen-based-oxidizing-agent-containing material is 30 wt % or more and 95 wt % or less.

[9] The composition according to any one of [6] to [8], wherein the content of the oxygen-based oxidizing agent in the composition is 5 wt % or more and 95 wt % or less.

[10] A method for producing the composition according to [6], comprising mixing a halogen-based-oxidizing-agent-containing material that contains a halogen-based oxidizing agent and a coating layer on its surface with an oxygen-based oxidizing agent.

[11] The production method according to [10], comprising bringing a coating liquid into contact with a surface of the halogen-based oxidizing agent to produce the halogen-based-oxidizing-agent-containing material.

[12] The composition according to any one of [1] to [5], wherein the composition is a composition comprising a halogen-based-oxidizing-agent-containing material that contains a halogen-based oxidizing agent and a coating layer on its surface, and an oxygen-based-oxidizing-agent-containing material that contains an oxygen-based oxidizing agent and a coating layer on its surface (the composition (3) in [2]).

[13] The composition according to [12], wherein the content of the halogen-based-oxidizing-agent-containing material in the composition is 5 wt % or more and 95 wt % or less.

[14] The composition according to [12] or [13], wherein the content of the halogen-based oxidizing agent in the halogen-based-oxidizing-agent-containing material is 30 wt % or more and 95 wt % or less.

[15] The composition according to any one of [12] to [14], wherein the content of the oxygen-based-oxidizing-agent-containing material in the composition is 5 wt % or more and 95 wt % or less.

[16] The composition according to any one of [12] to [15], wherein the content of the oxygen-based oxidizing agent in the oxygen-based-oxidizing-agent-containing material is 30 wt % or more and 95 wt % or less.

[17] A method for producing the composition according to [12], comprising mixing a halogen-based-oxidizing-agent-containing material that contains a halogen-based oxidizing agent and a coating layer on its surface with an oxygen-based-oxidizing-agent-containing material that contains an oxygen-based oxidizing agent and a coating layer on its surface.

[18] The production method according to [17], comprising bringing a coating liquid into contact with a surface of the oxygen-based oxidizing agent to produce the oxygen-based-oxidizing-agent-containing material.

[19] A method for treating a water area, comprising applying the composition according to any one of [1] to [9] and [12] to [16] to (i.e., bringing the composition into contact with) the water area.

[20] A method for treating pulp, comprising bringing the composition according to any one of [1] to [9] and [12] to [16] into contact with the pulp.

### Advantageous Effects of Invention

The composition of the present invention comprises a halogen-based oxidizing agent and an oxygen-based oxidizing agent, wherein the halogen-based oxidizing agent or the oxygen-based oxidizing agent, or both, are covered with a coating layer. This composition retains high water treatment capability while exhibiting excellent safety during use and excellent stability during storage. Specifically, during use, the composition has effects such as reducing water turbidity and removing organic matter in the target water area. Further, when water is added to the composition, heat generation is inhibited, whereby the composition is prevented from reaching a high temperature. Additionally, during storage, gas generation due to side reactions is inhibited, whereby swelling or breakage of a packaging container caused by the generated gas can be inhibited.

Furthermore, even if water is unintentionally added to the composition during production or use, heat generation or decomposition can be inhibited, enabling safe production and use.

In the present specification, “inhibit heat generation” means that when a predetermined amount of water is added to the composition, the highest temperature achieved by temperature rise due to heat generation of the composition is lower than that of a comparative composition, and/or when a predetermined amount of water is added to the composition, the time from when water is added to when the highest temperature is achieved by temperature rise due to heat generation of the composition is longer than that of a comparative composition. “Inhibit swelling of the packaging container” means that when the composition is sealed in a predetermined packaging container, the increase in volume of the packaging container is smaller than that of the same container containing a comparative composition. “Inhibit breakage of the packaging container” means that the degree of breakage of the packaging container is smaller than that of the same container containing a comparative composition.

### BRIEF DESCRIPTION OF DRAWINGS

FIG. 1 shows the results of a test for temperature change due to water contamination in Test Example 1.

FIG. 2 shows the results of a test for temperature change due to water contamination in Test Example 1.

FIG. 3 shows the results of a test for temperature change due to water contamination in Test Example 2.

FIG. 4 shows the results of a test for temperature change due to water contamination in Test Example 3.

FIG. 5 shows the results of a test for temperature change due to water contamination in Test Example 4.

FIG. 6 shows the results of a test for temperature change due to water contamination in Test Example 5.

FIG. 7 shows the results of a test for temperature change due to water contamination in Test Example 6.

FIG. 8 shows the results of a storage stability test (1 month of storage at 40° C./75% RH) for a 460 g aluminum pouch package (Comparative Example 14) in Test Example 7. (1) shows corrosion on the side of the aluminum pouch package, and (2) shows corrosion on the bottom of the aluminum pouch package.

FIG. 9 shows the results of a storage stability test (1.5 months of storage at 40° C./75% RH) for a 460 g aluminum pouch package (Comparative Example 14) in Test Example 7. (1) shows corrosion on the side of the aluminum pouch package, and (2) shows corrosion on the bottom of the aluminum pouch package.

FIG. 10 shows the results of a storage stability test (2 months of storage at 50° C./30% RH) for a 460 g aluminum pouch package (Comparative Example 14) in Test Example 7. Corrosion on the bottom of the aluminum pouch package is shown.

### DESCRIPTION OF EMBODIMENTS

### Composition

The composition of the present invention is characterized in that it comprises a halogen-based oxidizing agent and an oxygen-based oxidizing agent, wherein the halogen-based oxidizing agent or the oxygen-based oxidizing agent, or both, are covered with a coating layer.

Examples of this composition include the following embodiments (1) to (3):

(1) a composition comprising
a halogen-based-oxidizing-agent-containing material that contains a halogen-based oxidizing agent and a coating layer on its surface, and
an oxygen-based oxidizing agent,
   (2) a composition comprising
an oxygen-based-oxidizing-agent-containing material that contains an oxygen-based oxidizing agent and a coating layer on its surface, and
a halogen-based oxidizing agent, and
   (3) a composition comprising
a halogen-based-oxidizing-agent-containing material that contains a halogen-based oxidizing agent and a coating layer on its surface, and
an oxygen-based-oxidizing-agent-containing material that contains an oxygen-based oxidizing agent and a coating layer on its surface.

Among these, the composition (1) or (3) is preferred, and the composition (1) is more preferred.

The following describes the halogen-based oxidizing agent, the material containing a halogen-based oxidizing agent having a coating layer, the oxygen-based oxidizing agent, and the material containing an oxygen-based oxidizing agent having a coating layer, all of which can be contained in the composition of the present invention.

### Halogen-Based Oxidizing Agent

A halogen-based oxidizing agent is a compound that generates free halogen (hypohalous acids, such as hypochlorous acid, hypohalite ions, and molecular halogens, such as chlorine) when dissolved in water. Examples of the halogen-based oxidizing agent include at least one member selected from the group consisting of halogenated isocyanuric acids, alkali metal salts of halogenated isocyanuric acids, hydrates of alkali metal salts of halogenated isocyanuric acids, halogenated hydantoins, metal hypochlorites, and mixtures thereof.

Preferable examples of halogenated isocyanuric acids, alkali metal salts of halogenated isocyanuric acids, and hydrates of alkali metal salts of halogenated isocyanuric acids include at least one member selected from the group consisting of trichloroisocyanuric acid, sodium dichloroisocyanurate, hydrates of sodium dichloroisocyanurate, potassium dichloroisocyanurate, and mixtures thereof. In view of ease of availability and safety, more preferable examples include at least one member selected from the group consisting of trichloroisocyanuric acid, sodium dichloroisocyanurate, hydrates of sodium dichloroisocyanurate, and mixtures thereof.

Preferable examples of halogenated hydantoins include at least one member selected from the group consisting of 1,3-dichloro-5,5-dimethylhydantoin, 1-bromo-3-chloro-5,5-dimethylhydantoin, 1-chloro-3-bromo-5,5-dimethylhydantoin, 1,3-dibromo-5,5-dimethylhydantoin, 1,3-dichloro-5,5-ethylmethylhydantoin, and mixtures thereof. 1-Bromo-3-chloro-5,5-dimethylhydantoin and 1-chloro-3-bromo-5,5-dimethylhydantoin may be collectively referred to simply as “bromochloro-5,5-dimethylhydantoin.”

Preferable examples of metal hypochlorites include calcium hypochlorite (bleaching powder).

The halogen-based oxidizing agent is a solid and can be in the form of, for example, powder, granules, or tablets. Preferably, it is in powder form. These forms can be prepared by known methods. The average particle size of the halogen-based oxidizing agent is typically 1 to 5000 μm, preferably 10 to 3000 μm, and more preferably 50 to 2000 μm. The average particle size can be measured in accordance with the measurement method for “the average particle size of the composition” described below.

When the halogen-based oxidizing agent is a chlorine-based oxidizing agent, its effective chlorine content (in terms of Cl₂) can be calculated by using the iodine titration method. That is, iodine liberated by the reaction of active chlorine and potassium iodide is titrated with an aqueous sodium thiosulfate solution, and the effective chlorine content is calculated according to the following Equation 1.

$$Effective chlorine content ( \% ) = a \times f \times 0.35452 / b \qquad ( Equation 1 )$$

a: 0.1N aqueous sodium thiosulfate solution (ml) required for titration
b: Sample (g)
f: Factor of 0.1N aqueous sodium thiosulfate solution

The theoretical effective chlorine content of trichloroisocyanuric acid is 91.5%, that of sodium dichloroisocyanurate is 64.5%, and that of sodium dichloroisocyanurate dihydrate is 55.4%.

The halogen-based oxidizing agent is commercially available. For example, sodium dichloroisocyanurate and sodium trichloroisocyanurate can be easily obtained from Shikoku Chemicals Corporation under the trade name Neo-Chlor (registered trademark).

The content of the halogen-based oxidizing agent in the composition of the present invention is typically 5 to 95 wt %, preferably 8 to 90 wt %, more preferably 10 to 80 wt %, and particularly preferably 10 to 70 wt %.

### Material Containing a Halogen-Based Oxidizing Agent Having a Coating Layer

The material containing a halogen-based oxidizing agent has a structure in which the surface of a solid halogen-based oxidizing agent is covered with a coating layer. That is, the surface of the halogen-based oxidizing agent in the form of particles, granules, tablets, or the like is protected with a coating layer. The halogen-based oxidizing agent used here can be selected from those mentioned above.

The compound used for the coating layer is not particularly limited as long as it can coat the surface of the halogen-based oxidizing agent to inhibit the interaction between the halogen-based oxidizing agent and the oxygen-based oxidizing agent, and between the halogen-based oxidizing agent and other components.

Examples of compounds that can be used for the coating layer include metal salts of carboxylic acids, surfactants, polysaccharides, higher fatty acids, paraffin waxes, zeolites, and resins. These compounds can be used alone or in a combination of two or more. Examples of embodiments in which two or more compounds are used in combination include an embodiment in which two or more compounds are mixed to form a coating layer containing multiple compounds, and an embodiment in which a coating layer is formed by using one compound and then another coating layer is formed thereon by using another compound to make a multi-layer structure.

The phrase “the halogen-based oxidizing agent is covered with a coating layer” means a state in which the halogen-based oxidizing agent is completely or incompletely covered with a coating layer to an extent that the effects of the present invention are not impaired. Specifically, the state includes both a state in which the entire amount of the halogen-based oxidizing agent is covered with a coating layer and a state in which a portion of the halogen-based oxidizing agent is covered with a coating layer. The state also includes both a state in which the individual surfaces of the halogen-based oxidizing agent in the form of powder etc. are completely covered with a coating layer, and a state in which the individual surfaces thereof are partially covered with a coating layer.

For the compound that can be used for the coating layer, metal salts of carboxylic acids are preferred since they exhibit excellent solubility in water and excellent stability with the halogen-based oxidizing agent. Furthermore, metal salts of carboxylic acids are easy to process into a coating layer, have excellent functionality as a coating layer in protecting the halogen-based oxidizing agent, are easily available, and are easy to handle.

Examples of metal salts of carboxylic acids include at least one member selected from the group consisting of metal salts of aromatic carboxylic acids, metal salts of acyclic dicarboxylic acids, metal salts of acyclic monocarboxylic acids, metal salts of other carboxylic acids, and mixtures thereof. Metal salts of carboxylic acids may be, for example, those in which carboxyl groups in carboxylic acids are fully neutralized, forming metal salts, those in which carboxyl groups in carboxylic acids are partially neutralized, forming metal salts, or those including carboxylic acids that have yet to be formed into metal salts. Based on using a metal salt of a carboxylic acid, the material containing the halogen-based oxidizing agent having a coating layer and the composition comprising the material are stabilized by protecting the halogen-based oxidizing agent from degradation, deactivation, and decomposition, while effectively inhibiting the interaction between the halogen-based oxidizing agent and the oxygen-based oxidizing agent etc.

Furthermore, the coating layer formed by incorporating a metal salt of a carboxylic acid is stable even when in contact with the halogen-based oxidizing agent, and no adverse side reactions occur between the halogen-based oxidizing agent and the coating layer. Therefore, a coating layer can be directly provided on the surface of the halogen-based oxidizing agent without the necessity of providing another layer for separating the halogen-based oxidizing agent from the coating layer. In addition, the coating layer containing a metal salt of a carboxylic acid is preferred because it is less likely to aggregate and has excellent processability. Similarly, the coating layer can also be directly provided on the surface of the oxygen-based oxidizing agent.

“Metal salts of aromatic carboxylic acids” refer to metal salts of compounds that have an aromatic ring in the structure of the compound and that have a carboxyl group. Preferable examples of metal salts of aromatic carboxylic acids include at least one member selected from the group consisting of metal salts of benzoic acid, phthalic acid (ortho-phthalic acid), isophthalic acid (meta-phthalic acid), terephthalic acid (para-phthalic acid), trimellitic acid, and para-t-butylbenzoic acid, and mixtures thereof. Examples of metal salts include alkali metal salts, such as lithium salts, sodium salts, and potassium salts, and alkaline earth metal salts, such as calcium salts and magnesium salts. In view of ease of availability, alkali metal salts are preferred. In view of solubility in water, sodium salts and potassium salts are more preferred. Particularly preferable examples of metal salts of aromatic carboxylic acids include at least one member selected from the group consisting of alkali metal salts of benzoic acid, alkali metal salts of para-t-butylbenzoic acid, and mixtures thereof. A preferable example of alkali metal salts of benzoic acid is sodium benzoate. A preferable example of alkali metal salts of para-t-butylbenzoic acid is sodium para-t-butylbenzoate.

“Metal salts of acyclic dicarboxylic acids” refer to metal salts of compounds that do not have a cyclic structure in the structure of the compound and that have two carboxyl groups. Preferable examples of metal salts of acyclic dicarboxylic acids include at least one member selected from the group consisting of metal salts of oxalic acid, malonic acid, succinic acid, fumaric acid, maleic acid, D-tartaric acid, L-tartaric acid, D-malic acid, L-malic acid, D-aspartic acid, L-aspartic acid, glutaric acid, D-glutamic acid, L-glutamic acid, itaconic acid, adipic acid, pimelic acid, suberic acid, azelaic acid, sebacic acid, undecanedioic acid, dodecanedioic acid, and tetradecanedioic acid, and mixtures of these metal salts. Examples of metal salts include alkali metal salts, such as lithium salts, sodium salts, and potassium salts, and alkaline earth metal salts, such as calcium salts and magnesium salts. In view of ease of availability, alkali metal salts are preferred. In view of solubility in water, sodium salts and potassium salts are more preferred. More preferable examples of metal salts of acyclic dicarboxylic acids include at least one member selected from the group consisting of alkali metal salts of adipic acid, alkali metal salts of sebacic acid, alkali metal salts of undecanedioic acid, alkali metal salts of dodecanedioic acid, and mixtures thereof. A preferable example of alkali metal salts of adipic acid is disodium adipate. A preferable example of alkali metal salts of sebacic acid is disodium sebacate. A preferable example of alkali metal salts of undecanedioic acid is disodium undecanedioate. A preferable example of alkali metal salts of decanedioic acid is disodium dodecanedioate.

“Metal salts of acyclic monocarboxylic acids” refer to metal salts of compounds that do not have a cyclic structure in the structure of the compound and that have one carboxyl group. Preferable examples of metal salts of acyclic monocarboxylic acids include at least one member selected from the group consisting of metal salts of formic acid, acetic acid, propionic acid, butyric acid, valeric acid, hexanoic acid (caproic acid), heptanoic acid (enanthic acid), octanoic acid, nonanoic acid, decanoic acid, dodecanoic acid, lauric acid, myristic acid, palmitic acid, stearic acid, arachidic acid, behenic acid, oleic acid, linoleic acid, linolenic acid, acrylic acid, methacrylic acid, isobutyric acid, isovaleric acid, and mixtures thereof. Examples of metal salts include alkali metal salts, such as lithium salts, sodium salts, and potassium salts, and alkaline earth metal salts, such as calcium salts and magnesium salts. In view of ease of availability, alkali metal salts are preferred. In view of solubility in water, sodium salts and potassium salts are more preferred. More preferable examples of metal salts of acyclic monocarboxylic acids include at least one member selected from the group consisting of alkali metal salts of heptanoic acid (enanthic acid), alkali metal salts of octanoic acid, alkali metal salts of nonanoic acid, alkali metal salts of decanoic acid, alkali metal salts of dodecanoic acid, alkali metal salts of lauric acid, alkali metal salts of myristic acid, alkali metal salts of palmitic acid, alkali metal salts of stearic acid, and mixtures thereof. A preferable example of alkali metal salts of heptanoic acid (enanthic acid) is sodium heptanoate. A preferable example of alkali metal salts of octanoic acid is sodium octanoate. A preferable example of alkali metal salts of nonanoic acid is sodium nonanoate. A preferable example of alkali metal salts of decanoic acid is sodium decanoate. A preferable example of alkali metal salts of dodecanoic acid is sodium dodecanoate. A preferable example of alkali metal salts of lauric acid is sodium laurate. A preferable example of alkali metal salts of myristic acid is sodium myristate. A preferable example of alkali metal salts of palmitic acid is sodium palmitate. A preferable example of alkali metal salts of stearic acid is sodium stearate. Among the above, in view of effectively inhibiting heat generation, alkali metal salts of acyclic monocarboxylic acids with 7 to 20 carbon atoms, such as heptanoic acid, octanoic acid, and decanoic acid, are preferred.

“Metal salts of other carboxylic acids” refer to metal salts of compounds that may have a cyclic structure in the structure of the compound and that have three or more carboxyl groups. Preferable examples of metal salts of other carboxylic acids include metal salts of citric acid. Examples of metal salts include alkali metal salts, such as lithium salts, sodium salts, and potassium salts, and alkaline earth metal salts, such as calcium salts. In view of ease of availability, alkali metal salts are preferred. In view of solubility in water, sodium salts and potassium salts are more preferred. A preferable example of alkali metal salts of citric acid is trisodium citrate.

The metal salts of carboxylic acids that can be contained in the coating layer, i.e., metal salts of aromatic carboxylic acids, metal salts of acyclic dicarboxylic acids, metal salts of acyclic monocarboxylic acids, and metal salts of other carboxylic acids, may be used alone or in a combination of two or more of such compounds.

In the composition of the present invention, the content of the material containing the halogen-based oxidizing agent having a coating layer is typically 5 to 95 wt %, preferably 8 to 92 wt %, more preferably 10 to 80 wt %, and particularly preferably 10 to 70 wt %.

In the coating layer of the material containing the halogen-based oxidizing agent, the content of the metal salt of a carboxylic acid is preferably 30 wt % or more, more preferably 50 wt % or more, and even more preferably 70 wt % or more, based on the total weight of the coating layer taken as 100 wt %, in view of ease of forming a coating layer on the surface of the solid halogen-based oxidizing agent.

The coating layer may contain various compounds, such as inorganic compounds and organic compounds, as long as such compounds do not impair the effect of the present invention. Examples of inorganic compounds include, but are not limited to, phosphates, sulfates, silicates, chlorides, iodides, and bromides. Examples of organic compounds include, but are not limited to, polysaccharides, polymer compounds, and salts of organic compounds.

The proportion (wt %) of the coating layer in the material containing the halogen-based oxidizing agent having a coating layer is preferably within the following ranges. Specifically, in view of effectively inhibiting the interaction between the halogen-based oxidizing agent and other components with the coating layer, the lower limit of the proportion is preferably 5 wt % or more, more preferably 10 wt % or more, and even more preferably 15 wt % or more, based on the total weight of the material containing the halogen-based oxidizing agent taken as 100 wt %. Further, in view of exerting the effects mentioned above without excessively increasing the proportion of the coating layer, the upper limit is preferably 70 wt % or less, more preferably 50 wt % or less, and even more preferably 45 wt % or less.

The proportion (wt %) of the halogen-based oxidizing agent in the material containing the halogen-based oxidizing agent is preferably within the following ranges. Specifically, the lower limit of the proportion is preferably 30 wt % or more, more preferably 50 wt % or more, and even more preferably 55 wt % or more, based on the total weight of the material containing the halogen-based oxidizing agent taken as 100 wt %. Further, the upper limit is preferably 95 wt % or less, more preferably 90 wt % or less, and even more preferably 85 wt % or less.

When the halogen-based oxidizing agent is a chlorine-based oxidizing agent, the calculation method based on Equation 2 below can be used to calculate the proportion of the coating layer in the material containing the chlorine-based oxidizing agent having a coating layer.

$$Proportion of coating layer ( wt \% ) = Q 1 \times 100 / Q 2 \qquad ( Equation 2 )$$

Q1: Weight (g) of coating layer in the material containing the chlorine-based oxidizing agent having a coating layer
Q2: Weight (g) of material containing the chlorine-based oxidizing agent having a coating layer

For example, when 1 g of the material containing the chlorine-based oxidizing agent having a coating layer contains 0.3 g of the coating layer, the proportion (wt %) of the coating layer is calculated as 30 wt % from 0.3×100/1=30 according to Equation 2. The weight of the coating layer in the material containing the chlorine-based oxidizing agent having a coating layer may be determined, for example, by dissolving the material containing the chlorine-based oxidizing agent having a coating layer in a solvent, such as water, and analyzing the solution by a known analytical method, such as liquid chromatography, to quantify the weight of the compound used in the coating layer, or by subtracting the weight of the chlorine-based oxidizing agent from the weight of the material containing the chlorine-based oxidizing agent having a coating layer. The weight of the chlorine-based oxidizing agent may be quantified by using a known analytical method, such as liquid chromatography.

The identification and quantification of the coating layer can be made by already known measurement methods. For example, if the absorbance of the compound used to form the coating layer is known, the proportion (wt %) of the coating layer can be calculated by adjusting the compound used in the coating layer to a known concentration and creating a calibration curve (absorbance method). Alternatively, widely known methods, such as liquid chromatography or gas chromatography, may be used. When quantifying the halogen-based oxidizing agent is easier than quantifying the coating layer, the weight of the coating layer can be calculated from the weight of the halogen-based oxidizing agent.

When the halogen-based oxidizing agent is a chlorine-based oxidizing agent, the proportion of the coating layer can be calculated from the effective chlorine content of the material containing the chlorine-based oxidizing agent according to the following Equation 3. In this case, when the material containing the chlorine-based oxidizing agent having a coating layer contains other components, such as water, in addition to the coating layer, the proportion of the coating layer can be determined by subtracting the water content (or the content of the components other than the coating layer) (wt %) from the calculated value.

$$Proportion of the coating layer ( wt \% ) = ( P 1 - P 2 ) \times 100 / P 1 \qquad ( Equation 3 )$$

P1: Effective chlorine content (%) of the chlorine-based oxidizing agent used as a starting material
P2: Effective chlorine content (%) of the material containing the chlorine-based oxidizing agent having a coating layer

Specifically, for example, when a material containing the chlorine-based oxidizing agent having a coating layer is produced by using sodium dichloroisocyanurate with an effective chlorine content of 64.5% as the chlorine-based oxidizing agent and if the effective chlorine content of the material containing the chlorine-based oxidizing agent having a coating layer is 40.0%, the proportion of the coating layer is calculated as 38.0% according to Equation 3.

The content of the metal salt of a carboxylic acid contained in the coating layer of the material containing the chlorine-based oxidizing agent having a coating layer may be quantified by using a known analytical method, such as liquid chromatography. For example, if the content of the metal salt of a carboxylic acid in the material containing the chlorine-based oxidizing agent having a coating layer is 5 wt % and if the proportion of the coating layer in the material containing the chlorine-based oxidizing agent having a coating layer is 30 w %, the content of the metal salt of a carboxylic acid in the coating layer is calculated as 16.7 wt %, based on the total weight of the coating layer taken as 100 wt %.

The method for quantifying the proportion of the coating layer in the material containing the halogen-based oxidizing agent having a coating layer and the content of the compounds in the coating layer can be any of the methods described above, or any appropriate known methods. Even if there is an error in the results obtained by some measurement methods, as long as the numerical value obtained by any one of the measurement methods falls within the predetermined range, it can be regarded as satisfying the requirements even if the results obtained by other measurement methods fall outside the predetermined range.

The material containing the halogen-based oxidizing agent having a coating layer of the present invention can be produced by forming a coating layer on a solid halogen-based oxidizing agent. The production method is not particularly limited, and known methods, such as a stirring method, a rolling method, or a fluidized bed method, or a combination of these methods, may be used. By bringing a coating liquid containing a metal salt of a carboxylic acid and the like into contact with the surface of a solid halogen-based oxidizing agent, the material containing the halogen-based oxidizing agent can be produced. For example, the production can be performed based on or in accordance with the method disclosed in PTL 3.

When the halogen-based oxidizing agent is a chlorine-based oxidizing agent, the effective chlorine content (in terms of Cl₂) in the material containing the chlorine-based oxidizing agent can be calculated according to Equation 1 above by using the iodine titration method in the same manner as for the effective chlorine content (in terms of Cl₂) of the chlorine-based oxidizing agent alone. That is, iodine liberated by the reaction of active chlorine and potassium iodide is titrated with a sodium thiosulfate solution, and the effective chlorine content is calculated according to the following Equation 1.

The material containing the halogen-based oxidizing agent having a coating layer is a solid and can be in the form of, for example, powder, granules, or tablets. Preferably, it is in powder form. The average particle size of the material containing the halogen-based oxidizing agent having a coating layer is typically 1 to 5000 μm, preferably 10 to 3000 μm, and more preferably 50 to 2000 μm. The average particle size can be measured in accordance with the measurement method for “the average particle size of the composition” described below.

### Oxygen-Based Oxidizing Agent

“Oxygen-based oxidizing agents” refer to organic or inorganic peroxides, hydrogen peroxide adducts, or hydrogen peroxide. Examples include percarbonates, perborates, persulfates, and organic peroxides, such as peroxybenzoic acid. Example of percarbonates include a sodium carbonate hydrogen peroxide adduct (sometimes simply referred to as “sodium percarbonate”), which is obtained by adding hydrogen peroxide to sodium carbonate. Example of perborates include sodium perborate. Examples of persulfates include peroxysulfuric acid-sulfuric acid-pentapotassium salt, potassium peroxodisulfate, and mixtures thereof.

In view of ease of availability and ease of handling, the oxygen-based oxidizing agent is preferably at least one member selected from the group consisting of sodium percarbonate, sodium perborate, a peroxysulfuric acid-sulfuric acid-pentapotassium salt (e.g., Oxone (registered trademark) as an oxidizing agent containing a peroxysulfuric acid-sulfuric acid-pentapotassium salt), and mixtures thereof. In view of reactivity with organic substances and oxidizing power, an oxidizing agent containing a peroxysulfuric acid-sulfuric acid-pentapotassium salt is particularly preferred.

The oxygen-based oxidizing agent is a solid and can be in the form of, for example, powder, granules, or tablets. Preferably, it is in powder form. These forms can be prepared by known methods. The average particle size of the oxygen-based oxidizing agent is typically 1 to 5000 μm, preferably 10 to 3000 μm, and more preferably 50 to 2000 μm. The average particle size can be measured in accordance with the measurement method for “the average particle size of the composition” described below.

The effective oxygen content (in terms of O₂) in the oxygen-based oxidizing agent can be calculated by using the iodine titration method. That is, iodine liberated by the reaction of active oxygen and potassium iodide is titrated with a sodium thiosulfate solution, and the effective oxygen content is calculated according to the following Equation 4. To accelerate the reaction between active oxygen and potassium iodide, a small amount of an aqueous ammonium molybdate solution adjusted to 1 mass % may be added.

$$Effective oxygen content ( \% ) = a \times f \times 0.08 / b \qquad ( Equation 4 )$$

a: 0.1N sodium thiosulfate solution required for titration (mL)
b: Sample (g)
f: Factor of 0.1N sodium thiosulfate solution

The oxygen-based oxidizing agent is commercially available and can be easily obtained from Lanxess under the trade name Oxone (registered trademark).

The content of the oxygen-based oxidizing agent in the composition of the present invention is typically 5 to 95 wt %, preferably 8 to 90 wt %, more preferably 10 to 80 wt %, and particularly preferably 10 to 70 wt %.

### Material Containing an Oxygen-Based Oxidizing Agent Having a Coating Layer

The material containing an oxygen-based oxidizing agent has a structure in which the surface of a solid oxygen-based oxidizing agent is covered with a coating layer. That is, the surface of the oxygen-based oxidizing agent in the form of particles, granules, tablets, or the like is protected with a coating layer. The oxygen-based oxidizing agent used here can be selected from those mentioned above.

The compound used for the coating layer is not particularly limited as long as it can coat the surface of the oxygen-based oxidizing agent to inhibit the interaction between the oxygen-based oxidizing agent and the halogen-based oxidizing agent, and between the oxygen-based oxidizing agent and other components.

The compound that can be used for the coating layer may be those mentioned above in the “Material Containing a Halogen-based Oxidizing Agent Having a Coating Layer” section. These compounds can be used alone or in a combination of two or more. Examples of embodiments in which two or more compounds are used in combination include an embodiment in which two or more compounds are mixed to form a coating layer containing multiple compounds, and an embodiment in which a coating layer is formed by using one compound and then another coating layer is formed thereon by using another compound to make a multi-layer structure.

The phrase “the oxygen-based oxidizing agent is covered with a coating layer” means a state in which the oxygen-based oxidizing agent is completely or incompletely covered with a coating layer to an extent that the effects of the present invention are not impaired. Specifically, the state includes both a state in which the entire amount of the oxygen-based oxidizing agent is covered with a coating layer and a state in which a portion of the oxygen-based oxidizing agent is covered with a coating layer. The state also includes both a state in which the individual surfaces of the oxygen-based oxidizing agent in the form of powder etc. are completely covered with a coating layer, and a state in which the individual surfaces thereof are partially covered with a coating layer.

For the compound that can be used for the coating layer, metal salts of carboxylic acids are more preferred since they are easy to process into a coating layer, have excellent functionality as a coating layer in protecting the oxygen-based oxidizing agent, are easily available, and are easy to handle. Examples of metal salts of carboxylic acids include metal salts of aromatic carboxylic acids, metal salts of acyclic dicarboxylic acids, metal salts of acyclic monocarboxylic acids, metal salts of other carboxylic acids, and mixtures thereof.

In the composition of the present invention, the content of the material containing the oxygen-based oxidizing agent having a coating layer is typically 5 to 95 wt %, preferably 8 to 92 wt %, more preferably 10 to 80 wt %, and particularly preferably 10 to 70 wt %.

In the coating layer of the material containing the oxygen-based oxidizing agent, the content of the metal salt of a carboxylic acid is preferably 30 wt % or more, more preferably 50 wt % or more, and even more preferably 70 wt % or more, based on the total weight of the coating layer taken as 100 wt %, in view of ease of forming a coating layer on the surface of the solid oxygen-based oxidizing agent.

The coating layer may contain various compounds, such as inorganic compounds and organic compounds, as long as such compounds do not impair the effect of the present invention. Examples of inorganic compounds include, but are not limited to, phosphates, sulfates, silicates, chlorides, iodides, and bromides. Examples of organic compounds include, but are not limited to, polysaccharides, polymer compounds, and salts of organic compounds.

The proportion (wt %) of the coating layer in the material containing the oxygen-based oxidizing agent having a coating layer is preferably within the following ranges. Specifically, in view of effectively inhibiting the interaction between the oxygen-based oxidizing agent and other components with the coating layer, the lower limit of the proportion is preferably 5 wt % or more, more preferably 10 wt % or more, and even more preferably 15 wt % or more, based on the total weight of the material containing the oxygen-based oxidizing agent taken as 100 wt %. Further, in view of exerting the effects mentioned above without excessively increasing the proportion of the coating layer, the upper limit is preferably 70 wt % or less, more preferably 50 wt % or less, and even more preferably 45 wt % or less.

The proportion (wt %) of the oxygen-based oxidizing agent in the material containing the oxygen-based oxidizing agent is preferably within the following ranges. Specifically, the lower limit of the proportion is preferably 30 wt % or more, more preferably 50 wt % or more, and even more preferably 55 wt % or more, based on the total weight of the material containing the oxygen-based oxidizing agent taken as 100 wt %. Further, the upper limit is preferably 95 wt % or less, more preferably 90 wt % or less, and even more preferably 85 wt % or less.

The proportion of the coating layer in the material containing the oxygen-based oxidizing agent having a coating layer can be calculated according to the calculation method based on Equation 5 below.

$$Proportion of coating layer ( wt \% ) = Q 1 \times 100 / Q 2 \qquad ( Equation 5 )$$

Q1: Weight (g) of coating layer in the material containing the oxygen-based oxidizing agent having a coating layer
Q2: Weight (g) of material containing the oxygen-based oxidizing agent having a coating layer

The proportion of the coating layer can be calculated from the effective oxygen content of the material containing the oxygen-based oxidizing agent according to the following Equation 6. In this case, when the material containing the oxygen-based oxidizing agent having a coating layer contains other components, such as water, in addition to the coating layer, the proportion of the coating layer can be determined by subtracting the water content (or the content of the components other than the coating layer) (wt %) from the calculated value.

$$Proportion of the coating layer ( wt \% ) = ( P 1 - P 2 ) \times 100 / P 1 \qquad ( Equation 6 )$$

P1: Effective oxygen content (%) of the oxygen-based oxidizing agent used as a starting material
P2: Effective oxygen content (%) of the material containing the oxygen-based oxidizing agent having a coating layer

The method for quantifying the proportion of the coating layer in the material containing the oxygen-based oxidizing agent having a coating layer and the content of the compounds in the coating layer can be any of the methods described above, or any appropriate known methods. Even if there is an error in the results obtained by some measurement methods, as long as the numerical value obtained by any one of the measurement methods falls within the predetermined range, it can be regarded as satisfying the requirements even if the results obtained by other measurement methods fall outside the predetermined range.

The material containing the oxygen-based oxidizing agent having a coating layer of the present invention can be produced by forming a coating layer on a solid oxygen-based oxidizing agent. The production method is not particularly limited, and known methods, such as a stirring method, a rolling method, or a fluidized bed method, or a combination of these methods, may be used. By bringing a coating liquid containing a metal salt of a carboxylic acid and the like into contact with the surface of a solid oxygen-based oxidizing agent, the material containing the oxygen-based oxidizing agent can be produced. For example, the production can be performed based on or in accordance with the method disclosed in PTL 3.

The effective oxygen content (in terms of O₂) in the material containing the oxygen-based oxidizing agent can be calculated by using the iodine titration method in the same manner as for the effective oxygen content (in terms of O₂) of the oxygen-based oxidizing agent alone. That is, iodine liberated by the reaction of active oxygen and potassium iodide is titrated with a sodium thiosulfate solution, and the effective oxygen content is calculated according to the above Equation 4. To accelerate the reaction between active oxygen and potassium iodide, a small amount of an aqueous ammonium molybdate solution adjusted to 1 mass % may be added.

The material containing the oxygen-based oxidizing agent having a coating layer is a solid and can be in the form of, for example, powder, granules, or tablets. Preferably, it is in powder form. The average particle size of the material containing the oxygen-based oxidizing agent having a coating layer is typically 1 to 5000 μm, preferably 10 to 3000 μm, and more preferably 20 to 2000 μm. The average particle size can be measured in accordance with the measurement method for “the average particle size of the composition” described below.

The content of the oxidizing agent in the composition comprising a mixture of the material containing the chlorine-based oxidizing agent and the material containing the oxygen-based oxidizing agent can be defined as the “total oxidizing agent content.” As stated above in relation to Equation 1 and Equation 4, the effective chlorine content (or effective oxygen content) is calculated by titrating iodine liberated by the reaction of active chlorine (or active oxygen) and potassium iodide with an aqueous sodium thiosulfate solution. When the composition comprises a mixture of a chlorine-based oxidizing agent and an oxygen-based oxidizing agent, the total iodine liberated by the chlorine-based oxidizing agent and the oxygen-based oxidizing agent is titrated with an aqueous sodium thiosulfate solution. In this case, assuming that all the liberated iodine has been liberated by the chlorine-based oxidizing agent, the value calculated as the effective chlorine content according to Equation 1 is defined as the “total oxidizing agent content.” The decrease in the effective chlorine content or the effective oxygen content, or both, can be detected as a decrease in the total oxidizing agent content.

### Other Additives

The composition of the present invention can further comprise a combination of compounds beneficial for various water treatments. The composition of the present invention can comprise other additives, such as coagulants, organic acids, surfactants, chelating agents (metal ion scavengers), organic polymers, perfumes, dyes, enzymes, and inorganic substances, as long as the effect of the present invention is not impaired. Liquid additives as well as solid additives can be used. For example, liquid additives can be mixed beforehand with a porous inorganic powder, such as zeolites, and the liquid component may be supported on an inorganic substance and then incorporated.

The coagulant may be at least one member selected from the group consisting of inorganic coagulants, organic coagulants, and mixtures thereof. While coagulants may also be referred to as “flocculants,” coagulants and flocculants are not distinguished from each other in the present specification because they are classified as compound groups with the same effects.

Examples of inorganic coagulants include at least one member selected from the group consisting of aluminum sulfate, aluminum hydroxide, aluminum chloride, polyaluminum chloride (or PAC), alum (aluminum sulfate or potassium aluminum sulfate), aluminum oxide, ferric chloride, polyferric sulfate, ferrous sulfate, polysilica iron, slaked lime (including calcium hydroxide), and mixtures thereof.

Examples of organic coagulants include at least one polymer coagulant selected from the group consisting of anionic polymer coagulants, nonionic polymer coagulants, cationic polymer coagulants, amphoteric polymer coagulants, and mixtures thereof.

Examples of anionic polymer coagulants include copolymers of acrylamide and sodium acrylate, copolymers of acrylamide, sodium acrylate, and sodium 2-acrylamido-2-methylpropanesulfonate, and alkali metal salts of carboxymethylcellulose.

Examples of nonionic polymer coagulants include polyacrylamide, alginic acid and alkali metal salts thereof, pectin, carboxymethylcellulose, polyacrylic acid and alkali metal salts thereof, polymaleic acid and alkali metal salts thereof, and acrylic acid-maleic acid copolymers and alkali metal salts thereof.

Examples of cationic polymer coagulants include quaternary salts of polyalkylaminoalkylmethacrylates, copolymers of acrylamide and a quaternary salt of acrylic acid, acrylic acid, and alkylaminoalkyl(meth)acrylate, homopolymers of cationic monomers, such as dimethylaminoethyl acrylate or a quaternary salt thereof, and dimethylaminoethyl methacrylate or a quaternary salt thereof, and copolymers of the cationic monomers with acrylamide, as well as polyvinylamidine, poly(diallyldimethylammonium chloride) (PDADMAC), polyethyleneimine, polyallylamine, polyvinylamine, poly(2-vinyl-1-methylpyridinium), dialkylamine-epichlorohydrin polycondensates, polylysine, polyamidine hydrochloride, chitosan, and diethylaminoethyl dextran.

Examples of amphoteric polymer coagulants include copolymers of a cationic monomer, such as dimethylaminoethyl acrylate or a quaternary salt thereof and dimethylaminoethyl methacrylate or a quaternary salt thereof, a nonionic monomer, such as acrylamide, and acrylic acid or a salt thereof, as well as diallyldimethylammonium-acrylic acid copolymers and diallylmethylamine-maleic acid copolymers. The ionic nature of polymer coagulants may vary depending on the degree of polymerization or the degree of modification.

Among the above, the organic coagulant is preferably a cationic polymer coagulant having a quaternary ammonium salt, in view of neutralizing the surface charge of particles suspended in water and causing the particles to aggregate. For example, the organic coagulant is preferably a polymer of diallyldimethylammonium, a diallyldimethylammonium-acrylic acid copolymer, a diallylmethylamine-maleic acid copolymer, an alkali metal salt thereof, a halide (especially a chloride) thereof, or a mixture thereof, and more preferably poly(diallyldimethylammonium chloride) (PDADMAC), which is a type of a polymer of diallyldimethylammonium. These can be used as polymer coagulants. The weight average molecular weight of the polymer coagulant is not particularly limited, and is preferably 1000 or more and 50000000 or less, and more preferably 2000 or more and 30000000 or less.

When the composition comprises a coagulant, the content of the coagulant in the composition is preferably 0.01 wt % or more, more preferably 0.1 wt % or more, and even more preferably 0.3 wt % or more, based on the total weight of the composition taken as 100 wt %, in view of obtaining a sufficient coagulation effect. However, since no further improvement in the coagulation effect can be expected even with excessive addition, the content is preferably set at 20 wt % or less, more preferably 15 wt % or less, and even more preferably 10 wt % or less.

Organic acids are not particularly limited. In view of being a solid and ease of handleability at normal temperature and pressure, preferable examples of organic acids include at least one member selected from the group consisting of oxalic acid, malonic acid, succinic acid, fumaric acid, maleic acid, D-tartaric acid, L-tartaric acid, D-malic acid, L-malic acid, D-aspartic acid, L-aspartic acid, glutaric acid, D-glutamic acid, L-glutamic acid, citric acid, benzoic acid, and mixtures thereof. In view of excellent blending stability with the solid halogen-based oxidizing agent (hypochlorous acid generating source), such as sodium dichloroisocyanurate, more preferable examples of organic acids include at least one member selected from succinic acid, fumaric acid, and mixtures thereof.

Examples of usable surfactants include at least one member selected from the group consisting of anionic surfactants, non-ionic surfactants, cationic surfactants, amphoteric surfactants, and mixtures thereof.

Examples of anionic surfactants include at least one member selected from the group consisting of alkyl sulfate ester salts, such as ammonium lauryl sulfate; alkylbenzene sulfonates, such as sodium C₁₂-C₁₄ branched or linear alkylbenzene sulfonates; sulfonates, such as sodium C₁₄-C₁₈ α-olefin sulfonates; dialkylsulfosuccinates, such as sodium dialkylsulfosuccinate; alkyl phosphates, such as potassium alkyl phosphate; polyoxyethylene alkyl ether sulfate ester salts, such as sodium polyoxyethylene lauryl ether sulfate; alkyl sulfosuccinates, such as sodium alkyl sulfosuccinate; and mixtures of these.

Examples of non-ionic surfactants include at least one member selected from the group consisting of alkyl ethers, such as lauryl alcohol alkoxylate; polyoxyethylene alkyl ethers, such as polyoxyethylene higher alcohol ether; EO-PO block polymers, such as polyoxyethylene-polyoxypropylene block polymers, reverse-type polyoxyethylene-polyoxypropylene block polymers, polyoxyethylene-polyoxypropylene condensates, polyoxyethylene-polyoxypropylene block polymers of ethylenediamine, and reverse-type polyoxyethylene-polyoxypropylene block polymers of ethylenediamine; sorbitan fatty acid esters, such as sorbitan laurate; polyoxyethylene sorbitan fatty acid esters, such as polyoxyethylene sorbitan stearate; polyethylene glycol fatty acid esters, such as polyethylene glycol laurate; polyoxyethylene alkylamines, such as ethylenediamine-polyoxyethylene-polyoxypropylene block polymers; alkyl alkanolamides, such as lauric acid monoethanolamide; glycerin fatty acid (e.g., stearic acid) esters; sucrose fatty acid esters; and mixtures thereof.

Examples of cationic surfactants include at least one member selected from the group consisting of alkyl amine salts, such as stearyl amine acetate; quaternary ammonium salts, such as distearyl dimethyl ammonium salts, diisotetradecyldimethyl ammonium salts, cetylpyridinium chloride, benzethonium chloride, benzalkonium chloride, and didecyldimethylammonium chloride; and mixtures thereof.

Examples of amphoteric surfactants include alkyl betaines, such as lauryl betaine, stearyl betaine, and 2-alkyl-N-carboxymethyl-N-hydroxyethyl imidazolinium betaine; amine oxides, such as lauryl dimethylamine oxide; and at least one member selected from the group consisting of these surfactants.

The surfactant is preferably an anionic surfactant, and more preferably at least one member selected from the group consisting of sodium linear alkylbenzene sulfonate, sodium α-olefin sulfonate, sodium alkyl sulfate, and mixtures thereof, in view of excellent blending stability with the halogen-based oxidizing agent, such as sodium dichloroisocyanurate, and the oxygen-based oxidizing agent.

When the coating layer of the material containing the halogen-based oxidizing agent having a coating layer or the material containing the oxygen-based oxidizing agent having a coating layer contains a surfactant, the content of the surfactant in the composition, including the content of the surfactant in the coating layer, is preferably 0.1 wt % or more, more preferably 1 wt % or more, and even more preferably 2 wt % or more, based on the weight of the composition, in view of obtaining sufficient surfactant effects.

The content of the surfactant in the composition is preferably 20 wt % or less, more preferably 10 wt % or less, and even more preferably 8 wt % or less, based on the weight of the composition.

Examples of organic polymers include organic polymers other than the compounds listed above in terms of organic coagulants. Examples include at least one organic polymer selected from the group consisting of polysaccharides, such as carrageenan, guar gum, locust bean gum, alkali metal salts of alginic acid, dextrin, xanthan gum, starch, and derivatives thereof; and methyl cellulose, ethyl cellulose, hydroxypropyl cellulose, hydroxyethyl cellulose, other cellulose derivatives, and mixtures thereof. Other examples include at least one organic polymer selected from the group consisting of polyvinyl alcohol, polyethylene glycol, olefin-maleic anhydride copolymers and alkali metal salts thereof, acrylic acid-sulfonic acid copolymers and alkali metal salts thereof, and mixtures thereof.

Although the primary use of these organic polymers is not as coagulants, they may be used as coagulants, depending on the quality of the water to be treated. Alternatively, the organic polymers may be added to the water treatment agent with the expectation of serving roles such as viscosity adjustment, dispersants for hardness components (agents for preventing precipitation of calcium and magnesium salts), prevention of dirt redeposition, and auxiliary agents for coagulants. It is also possible to use a combination of multiple organic polymers.

When the composition comprises an organic polymer, the content of the organic polymer is preferably 0.01 to 10 wt %, more preferably 0.1 to 7 wt %, and even more preferably 0.5 to 5 wt %, based on the total weight of the composition.

Examples of usable chelating agents include at least one member selected from the group consisting of amino carboxylic acid derivatives, such as nitrilotriacetic acid, ethylenediaminetetraacetic acid, β-alanine diacetic acid, aspartic acid diacetic acid, methylglycine diacetic acid, iminodisuccinic acid, glutamic acid diacetic acid, metal salts thereof, and hydrates thereof; hydroxyaminocarboxylic acids, such as serine diacetic acid, hydroxyiminodisuccinic acid, hydroxyethyl ethylenediaminetriacetic acid, dihydroxyethylglycine, metal salts thereof, and hydrates thereof; phosphonocarboxylic acid derivatives, such as tripolyphosphoric acid, 1-diphosphonic acid, α-methylphosphonosuccinic acid, 2-phosphonobutane-1,2-dicarboxylic acid, metal salts thereof, and hydrates thereof; and mixtures of these. In terms of ease of availability, ease of handling, and metal ion-scavenging effect, at least one chelating agent selected from the group consisting of aminocarboxylic acid metal salts, hydrates of aminocarboxylic acid metal salts, hydroxyaminocarboxylic acid metal salts, hydrates of hydroxyaminocarboxylic acid metal salts, and mixtures thereof is preferred. A preferred example of metal salts of chelating agents is a sodium salt. In view of excellent stability with the halogen-based oxidizing agent and oxygen-based oxidizing agent, the chelating agent is more preferably sodium nitrilotriacetate. When the composition comprises a chelating agent, the content of the chelating agent in the composition is preferably 0.1 to 80 wt %, more preferably 1 to 60 wt %, and even more preferably 1 to 40 wt %, based on the weight of the composition, in view of metal ion-scavenging effects.

In addition to the inorganic coagulants mentioned above, examples of inorganic substances include sulfates, acetates, carbonates, alkali metal hydroxides, alkaline earth metal hydroxides, alkali metal chlorides, aluminum sulfates, siloxanes, clay minerals, and boron compounds. Inorganic substances can be added as additives, such as builders (fillers) of the composition, stabilizers for pH adjustment, viscosity adjustment, fluidity improvement, or swelling prevention, and labeled substances for concentration management. When the composition comprises an inorganic substance, the content of the inorganic substance in the composition is preferably 0.1 to 60 wt %, more preferably 1 to 40 wt %, and even more preferably 1 to 20 wt %, based on the weight of the composition.

Examples of sulfates include alkali metal salts of sulfuric acid, such as lithium sulfate, sodium sulfate, and potassium sulfate; and alkaline earth metal salts of sulfuric acid, such as magnesium sulfate and calcium sulfate. Examples of acetates include alkali metal salts of acetic acid, such as sodium acetate and potassium acetate; and alkaline earth metal salts of acetic acid, such as magnesium acetate and calcium acetate. Examples of carbonates include sodium hydrogen carbonate, potassium hydrogen carbonate, sodium carbonate, and lithium carbonate. Examples of alkali metal hydroxides include sodium hydroxide, potassium hydroxide, and lithium hydroxide. Examples of alkaline earth metal hydroxides include calcium hydroxide, magnesium hydroxide, and barium hydroxide. Examples of alkali metal chlorides include lithium chloride, sodium chloride, and potassium chloride. Examples of clay minerals include hectorite. Examples of boron compounds include borax, boric acid, metaboric acid, and boron oxide. Examples of siloxanes include dimethylpolysiloxane. These inorganic substances may be incorporated into the composition singly or in a combination of two or more.

### Preparation of the Composition

The composition of the present invention is characterized by comprising a halogen-based oxidizing agent and an oxygen-based oxidizing agent, wherein the halogen-based oxidizing agent or the oxygen-based oxidizing agent, or both, are covered with a coating layer. Examples of the composition include the embodiments (1) to (3) described above.

In the composition (1) above, the content of the oxygen-based oxidizing agent in the composition is typically 5 to 95 wt %, preferably 8 to 90 wt %, more preferably 10 to 80 wt %, and particularly preferably 10 to 70 wt %.

The content of the material containing the halogen-based oxidizing agent having a coating layer in the composition is typically 5 to 95 wt %, preferably 8 to 92 wt %, more preferably 10 to 80 wt %, and particularly preferably 10 to 70 wt %.

The content of the halogen-based oxidizing agent in the material containing the halogen-based oxidizing agent is typically 30 to 95 wt %, preferably 40 to 85 wt %, more preferably 50 to 80 wt %, and particularly preferably 60 to 80 wt %.

When the composition comprises a coagulant, the content of the coagulant in the composition is typically 0.01 to 20 wt %, preferably 0.1 to 15 wt %, and more preferably 0.3 to 10 wt %.

In the composition (2) above, the content of the halogen-based oxidizing agent in the composition is typically 5 to 95 wt %, preferably 8 to 90 wt %, more preferably 10 to 80 wt %, and particularly preferably 10 to 70 wt %.

The content of the material containing the oxygen-based oxidizing agent having a coating layer in the composition is typically 5 to 95 wt %, preferably 8 to 92 wt %, more preferably 10 to 80 wt %, and particularly preferably 10 to 70 wt %.

The content of the oxygen-based oxidizing agent in the material containing the oxygen-based oxidizing agent is typically 30 to 95 wt %, preferably 40 to 85 wt %, more preferably 50 to 80 wt %, and particularly preferably 55 to 80 wt %.

When the composition comprises a coagulant, the content of the coagulant in the composition is typically 0.01 to 20 wt %, preferably 0.1 to 15 wt %, and more preferably 0.3 to 10 wt %.

In the composition (3) above, the content of the halogen-based oxidizing agent having a coating layer in the composition is typically 5 to 95 wt %, preferably 8 to 93 wt %, more preferably 10 to 80 wt %, and particularly preferably 10 to 70 wt %.

The content of the halogen-based oxidizing agent in the material containing the halogen-based oxidizing agent is typically 30 to 95 wt %, preferably 40 to 85 wt %, more preferably 50 to 80 wt %, and particularly preferably 60 to 80 wt %.

The content of the material containing the oxygen-based oxidizing agent having a coating layer in the composition is typically 5 to 95 wt %, preferably 8 to 92 wt %, more preferably 10 to 80 wt %, and particularly preferably 55 to 80 wt %.

The content of the oxygen-based oxidizing agent in the material containing the oxygen-based oxidizing agent is typically 30 to 95 wt %, preferably 40 to 85 wt %, more preferably 50 to 80 wt %, and particularly preferably 55 to 80 wt %.

When the composition comprises a coagulant, the content of the coagulant in the composition is typically 0.01 to 20 wt %, preferably 0.1 to 15 wt %, and more preferably 0.3 to 10 wt %.

Among the embodiments (1) to (3), the composition (1) or (3) is preferred, and the composition (1) is more preferred.

The composition of the present invention is a solid and can be in the form of, for example, powder, granules, or tablets. Preferably, it is in powder form. The average particle size of the composition is typically 1 to 5000 μm, preferably 10 to 3000 μm, and more preferably 20 to 2000 μm. The average particle size can be measured in the following manner.

A 13-stage sifter with mesh openings of 75 μm, 106 μm, 150 μm, 250 μm, 425 μm, 600 μm, 710 μm, 850 μm, 1000 μm, 1180 μm, 1400 μm, 1700 μm, and 2000 μm is used with a receiving saucer. Each sieve of the sifter is stacked above the receiving saucer in such a manner that a sieve with a larger mesh opening is positioned at an upper stage. A sample is placed on the uppermost sieve with a mesh opening of 2000 μm, and the stacked sieves are supported with one hand and the sieve frame is tapped at a rate of approximately 120 times per minute. Occasionally, the sieve is positioned horizontally and the sieve frame is tapped hard several times. This operation is repeated to fully sift the sample. If the sample is agglomerated due to static electricity etc. or if fine powder adheres to the inside or back surface of the sieve, the sample is gently loosened with a brush, and the sieving operation is repeated. The sample that has passed through the sieve mesh is regarded as sieved-down. “Sieved-down” refers to a test sample that has passed through the sieve mesh by the end of sieving. If the sample contains particles having a particle size exceeding 2000 μm, sieves with mesh openings of 2360 μm, 2800 μm, 3350 μm, 4000 μm, 4750 μm, 5600 μm, or larger may be added. If the sample contains many particles having a particle size of 75 μm or less, sieves with mesh openings of 63 μm, 53 μm, 45 μm, 38 μm, or smaller may be added.

The mass of particles remaining on each sieve and on the receiving saucer is measured, and the mass percentage (%) of particles on each sieve is calculated. The mass percentage of particles is integrated by adding up the mass percentages of the particles on the sieves with smaller mesh openings in ascending order from the receiving saucer. If the mesh opening of the first sieve that achieves an integrated mass percentage of 50% or more is a μm, the mesh opening of the sieve one stage larger than a μm is b μm, the mass percentage integrated from the receiving saucer to the sieve with an opening mesh of a μm is c %, and the mass percentage of particles on the sieve with an opening mesh of a μm is d %, the average particle size can be obtained according to the following Equation 7.

$$S = \frac{50 - ( c - \frac{d}{log b - log a} \times log b )}{\frac{d}{log b - log a}} \qquad ( Equation 7 )$$

$$Average particle size ( μ m ) = {10}^{s}$$

The composition of the present invention can be produced by mixing a halogen-based oxidizing agent with an oxygen-based oxidizing agent, wherein the halogen-based oxidizing agent or the oxygen-based oxidizing agent, or both, have a coating layer. During mixing, other additives may also be added.

Specifically, the composition (1) above can be prepared by mixing a halogen-based-oxidizing-agent-containing material that contains a halogen-based oxidizing agent and a coating layer on its surface with an oxygen-based oxidizing agent. The composition (2) above can be prepared by mixing an oxygen-based-oxidizing-agent-containing material that contains an oxygen-based oxidizing agent and a coating layer on its surface with a halogen-based oxidizing agent. The composition (3) above can be prepared by mixing a halogen-based-oxidizing-agent-containing material that contains a halogen-based oxidizing agent and a coating layer on its surface with an oxygen-based-oxidizing-agent-containing material that contains an oxygen-based oxidizing agent and a coating layer on its surface.

Specifically, the mixing is performed by placing the components to be contained in the composition in a known mixer and mixing them to obtain a mixture (composition). The obtained composition can be packaged in small containers, such as films, pouches, and bottles. The container is not particularly limited as long as it can safely and stably store the composition. Examples of the container include aluminum laminated film, aluminum pouches, and resin bottles.

### Application and Use Method of Composition

The composition of the present invention has excellent cleaning and bleaching abilities and can be used for a wide range of applications.

For example, the composition of the present invention can be used for cleaning, disinfecting, and purifying a wide range of water areas, such as pools, spas, fountains, hot tubs, cooling towers, and other water circulation facilities for landscaping or industrial purposes. Specifically, the target water area can be purified by treating the water area with the composition of the present invention. More specifically, the composition of the present invention can be used as a pool shock agent, a water-clarifying agent (for improving transparency), or an organic compound-reducing agent.

The composition of the present invention can be safely stored and used because the heat generation that would occur when the composition comes into contact with a small amount of water is reduced. Further, when stored in a packaged state, the composition of the present invention reduces the interaction between the halogen-based oxidizing agent and the oxygen-based oxidizing agent, inhibiting the swelling and breakage of the packaging container. As a result, the composition of the present invention is easy to handle because active ingredients are inhibited from deterioration and can be stored for a longer period of time.

In order for the effect of the composition of the present invention to be exhibited effectively, particularly when treating pool water, the concentration of the composition in the aqueous solution after addition to the water area is preferably 0.1 to 1000 mg/L, more preferably 0.1 to 500 mg/L, and even more preferably 0.5 to 100 mg/L. Higher concentrations of the composition tend to be more effective; however, even if an excessive amount is added, no further improvement in effectiveness can be expected. In addition, if the concentration of the oxidizing agent is too high due to the excessive addition of the composition, there may be an increase in the production of nitrogen trichloride, which irritates mucous membranes, such as the eyes, nose, and throat, and causes unpleasant odors. Therefore, it is preferable to avoid excessively high composition concentrations.

It is recommended that the concentration of the composition and the effective chlorine concentration be used within appropriate ranges in accordance with the laws, regulations, and guidelines of the country or region where the composition is used. For example, in Japan, the notification from the Ministry of Health, Labour and Welfare (Health Policy Bureau Notification No. 0528003, dated May 28, 2007) states that as the sanitary standards for swimming pools, the concentration of free residual chlorine (hereinafter sometimes referred to as “free chlorine”) during swimming is desirably 0.4 mg/L or more and 1.0 mg/L or less. Therefore, when treating pool water using the present composition, if there is a possibility of exceeding the free chlorine concentration recommended by the sanitary standards, it is preferable to perform the treatment at night when there are no swimmers or on days when the pool is closed. When using the present composition in countries or regions other than Japan, it is recommended to use it in compliance with the laws, regulations, and guidelines established in each country or region. The concentration and treatment time can be adjusted as appropriate depending on the purpose of the water to be treated, water quality, usage temperature, and the desired degree of treatment.

The effects of the present composition are explained based on the following estimation principle, but are not limited to this principle.

For example, a case in which the present composition is applied to water areas, such as swimming pools, is explained. In general, when there are more swimmers in the pool water, organic compounds accumulate in the water. These organic compounds include proteins and various compounds contained in sweat, sebum, and in some cases, blood and urine.

Chlorine-based oxidizing agents (hereinafter also referred to as “chlorine agents”) produce active chlorine (free chlorine: free hypochlorous acid molecules), such as hypochlorous acid, when added to water, and active chlorine contributes to disinfection. As the number of swimmers increases and the concentration of organic compounds rises, it not only causes turbidity and odor in the pool water, but also the free chlorine added to disinfect the pool water becomes deactivated by reacting with these organic compounds, or combines with nitrogen-containing organic compounds, such as proteins, and nitrogen sources, such as ammonia, to form combined chlorine (chloramines: molecules in which nitrogen atoms and chlorine atoms are bonded). Since combined chlorine has lower disinfecting power than free chlorine, it is not preferable that free chlorine changes into combined chlorine. Furthermore, nitrogen trichloride, which is a type of chloramine, is highly volatile, has an irritating odor, and irritates mucous membranes. This causes deterioration of swimming environments, such as indoor pools. Thus, the production of nitrogen trichloride is particularly undesirable.

As a solution to this problem, it is effective to replace the pool water with a high concentration of organic compounds. However, since water replacement is very costly and cannot be easily implemented, chemical treatments may be used to reduce the concentration of organic compounds in the pool water. As one of such chemical treatments, a method called “high-concentration chlorine treatment” (also known as “shock treatment”) may be used. When the concentration of the chlorine agent in water is increased above normal levels, hypochlorous acid reacts with nitrogen-containing organic compounds and other nitrogen sources, decomposing chloramines into nitrogen, which can reduce the amounts of nitrogen and combined chlorine in the water. Through this treatment, organic compounds in the water are decomposed, with some being oxidized and broken down into nitrogen and carbon dioxide, which are then vaporized and discharged from the system. As a result, the concentration of organic compounds (consumption of potassium permanganate) in the water may decrease.

On the other hand, if too much chlorine agent is added at this time, nitrogen trichloride and other by-products are more likely to be produced; thus, care should be taken not to increase the concentration of the chlorine agent too high.

Therefore, a composition like the composition of the present invention, which is a mixture of a chlorine agent and an oxygen-based oxidizing agent (peroxysulfuric acid-sulfuric acid-pentapotassium salt), can temporarily increase the concentration of the chlorine agent due to the chlorine agent in the composition. In addition, the peroxysulfuric acid-sulfuric acid-pentapotassium salt can re-oxidize deactivated chloride ions in water back to active chlorine. This allows for maintaining the active chlorine concentration without significantly increasing the amount of the chlorine agent added, thus reducing the risk of side effects, such as nitrogen trichloride production caused by the excessive addition of the chlorine agent.

The purpose of use of the present composition is to reduce the concentrations of nitrogen sources and organic compounds derived from organic compounds, ammonia, etc. in pool water. The expected effects include a reduction in the concentration of organic compounds in pool water (reduced consumption of potassium permanganate), clarification (improved transparency), and inhibition of the production of undesirable by-products, such as nitrogen trichloride. In addition, by maintaining the chlorine concentration of the pool water, it is expected to have effects of preventing microbial contamination, such as biofilm formation, on the surfaces of circulation paths and pool interior walls, and of inhibiting algae growth in dormant pools.

For example, when using the composition of the present invention for the treatment of pool water, it is preferable to add the composition while operating a circulation system, such as a filter, to quickly dissolve the composition. The composition may be directly added to the pool tank, or if there is a disinfectant injection tank or disinfectant injection device installed in the circulation path, the composition may be added from there. However, it is preferable to use the composition when the pool is not in use (when there are no swimmers) because the effective chlorine concentration of the pool water temporarily rises due to the addition of the composition.

When the present composition is added, the treatment effect (purification effect) on the water area is exhibited by the composition of the present invention. Therefore, particularly when treating pool water, it is preferable that the free chlorine concentration of the pool water is 0.01 mg/L or more, more preferably 0.05 mg/L or more, even more preferably 0.1 mg/L or more, and most preferably 0.2 mg/L or more. On the other hand, in view of avoiding the effects of active chlorine on materials and piping, as well as preventing the production of nitrogen trichloride as described above, it is preferable that the free chlorine concentration of the aqueous solution after adding the composition to water is 20 mg/L or less, more preferably 15 mg/L or less, even more preferably 10 mg/L or less, and most preferably 8 mg/L or less. The concentration can be adjusted as appropriate depending on the swimming load in the pool water and differences such as whether it is an outdoor or indoor pool.

The frequency of use of the present composition can be about once a week, separate from the regular continuous chlorine management. The present composition can also be added before the pool is closed, or just before the pool is reopened for swimming after being closed for a while. When the chlorine concentration is maintained at a level that does not affect swimmers, the present composition may be added alongside regular continuous chlorine management.

The composition of the present invention can be used to treat water in spas and bath facilities for the same purposes as in swimming pools, and can also be used to improve the quality of water such as landscape water (fountains and ornamental ponds).

PTL 2 (US Patent Application Publication No. 2006/0078584) is incorporated herein by reference in its entirety.

The composition of the present invention can also be used for pulp treatment (particularly pulp bleaching). Conventionally, chlorine-based or oxygen-based oxidizing agents have been used as bleaching agents for bleaching pulp. The use of a chlorine-based oxidizing agent for pulp bleaching provides an excellent effect of efficiently decomposing residual lignin in the pulp. On the other hand, in consideration of the environmental impact of organic chlorine compounds that may be produced as by-products when bleaching the pulp with a chlorine-based oxidizing agent, there are cases in which ECF (elementary chlorine free) bleaching methods, which minimize the use of chlorine compounds, are desired. Specifically, mechanical pulp, kraft pulp, and recycled paper pulp, which are produced through mechanical or chemical pulping treatment from wood and waste paper, have colors ranging from dark brown to cream, depending on the type of wood and the defibration process. In order to bleach these types of pulp, bleaching agents that decompose lignin contained in the pulp are necessary. By treating the pulp with the composition of the present invention, it is possible to produce bleached white pulp by allowing both the chlorine-based oxidizing agent and oxygen-based oxidizing agent to act on the pulp while suppressing the use of the chlorine-based oxidizing agent. Furthermore, as described above, the composition as an example of the present invention, which is a mixture of a chlorine-based oxidizing agent and an oxygen-based oxidizing agent (peroxysulfuric acid-sulfuric acid-pentapotassium salt), can temporarily increase the concentration of active chlorine in water due to the chlorine-based oxidizing agent in the composition. In addition, the peroxysulfuric acid-sulfuric acid-pentapotassium salt can re-oxidize deactivated chloride ions in water back to active chlorine. As a result, it is possible to maintain the active chlorine concentration without significantly increasing the amount of chlorine-based oxidizing agent added, thereby reducing the risk of adverse environmental effects caused by the excessive addition of the chlorine-based oxidizing agent.

The whiteness of pulp materials decreases over time. A bleached pulp material with reduced whiteness can also be treated with the composition of the present invention to improve its whiteness.

Specifically, pulp materials, such as pulp and bleached pulp, can be treated (brought into contact) with a solution (aqueous solution) containing the composition of the present invention, thereby obtaining pulp materials with improved desired whiteness. For example, a pulp material with improved whiteness can be obtained by adding the composition of the present invention to an aqueous solution with a pulp concentration adjusted to about 3 to 15 mass % so that the concentration of the composition is 0.1 to 30 mass % under temperature conditions of 30 to 80° C. and pH conditions that are either alkaline (pH of 8 to 11) or acidic (pH of 3 to 6), thereby bringing the composition of the present invention into contact with the pulp, and performing treatment for a reaction time of about 1 to 3 hours. Further, depending on the purpose, oxidizing agents, reducing agents, chelating agents, fluorescent brighteners, and other additives can be added to the solution containing the composition of the present invention. In addition to the composition of the present invention, the process may further include a step of bringing a chlorine-based oxidizing agent or an oxygen-based oxidizing agent alone into contact with the pulp, may further include a step of bringing a reducing bleaching agent, such as hydrosulfite, into contact with the pulp, may include a step of bringing ozone or chlorine dioxide into contact with the pulp, and may include a neutralization or washing step as a post-treatment. Various types of pulp can be used, such as kraft pulp, mechanical pulp, and recycled paper pulp.

### EXAMPLES

The present invention is described specifically with reference to Examples and Comparative Examples. However, the present invention is not limited to these Examples. The starting materials and experimental equipment used in the Examples and Comparative Examples are as follows.

### Starting Materials

Sodium dichloroisocyanurate: produced by Shikoku Chemicals Corporation, trade name: Neo-Chlor 60MG (a halogen-based oxidizing agent; hereinafter also referred to as “SDIC”) (actual effective chlorine content: 62.7%, average particle size: 339 μm)
Sodium benzoate (component of coating layer): a reagent (produced by Fujifilm Wako Pure Chemical Corporation)
Decanoic acid: a reagent (produced by Fujifilm Wako Pure Chemical Corporation)
Sodium hydroxide: a reagent (produced by Fujifilm Wako Pure Chemical Corporation)
Aqueous sodium decanoate solution: decanoic acid was dispersed in distilled water, and an equivalent amount of sodium hydroxide was added and stirred to thereby obtain an aqueous sodium decanoate solution (concentration of sodium decanoate: 20 wt %)
Heptanoic acid: a reagent (produced by Fujifilm Wako Pure Chemical Corporation)
Aqueous sodium heptanoate solution: heptanoic acid was dispersed in distilled water, and an equivalent amount of sodium hydroxide was added and stirred to thereby obtain an aqueous disodium heptanoate solution (concentration of sodium heptanoate: 20 wt. %)
Oxone (an oxygen-based oxidizing agent containing a peroxysulfuric acid-sulfuric acid-pentapotassium salt; hereinafter also referred to as “OX” or “OXONE” (registered trademark): produced by Lanxess, trade name: Oxone (registered trademark) (actual effective oxygen content: 4.81%, average particle size: 386 μm)
Poly(diallyldimethylammonium chloride) (a polymer coagulant, hereinafter also referred to as “PDADMAC”)

Aluminum laminated film (for 30 g storage stability test) Material composition (μm) (outer layer) PET12/AL7/CPP50 Aluminum laminated pouch bag (for 460 g storage stability test) Material composition (μm): (outer layer) polyester/AL/PE80 Rolling granulator
DPZ-1, produced by As One Corporation pH meter
F-51, produced by Horiba, Ltd. pH electrode
9615S-10D, produced by Horiba, Ltd.

### Measurement of Total Oxidizing Agent Content and Calculation of Retention

The total oxidizing agent content (in terms of Cl₂) of each of the compositions of the Examples and Comparative Examples was calculated by using the iodine titration method described above according to the following equation. The following equation is substantially the same as Equation 1.

$$Total oxidizing agent content ( effective chlorine content ) ( \% ) = a \times f \times 0.35452 / b$$

a: 0.1N aqueous sodium thiosulfate solution (ml) required for titration
b: Sample (g)
f: Factor of 0.1N aqueous sodium thiosulfate solution

The total oxidizing agent content retention was calculated by dividing the total oxidizing agent content of the composition after a certain period of time by the total oxidizing agent content of the composition before the start of the test, with the total oxidizing agent content of the composition before the start of the test set as 100%.

### Percentage of Coating Layer

The percentage of the coating layer used in the Examples was calculated by using Equation 3 for the material containing a chlorine-based oxidizing agent, and Equation 6 for the material containing an oxygen-based oxidizing agent.

### Measurement of pH

The compositions of the Examples and Comparative Examples were dissolved in distilled water to prepare 1 wt % aqueous solutions, and the temperature of each aqueous solution was adjusted to 25° C. Using about 50 ml of each aqueous solution after stirring, the pH was measured with a pH meter. The pH meter was subjected to a three-point calibration using pH 4, pH 7, and pH 9 standard solutions immediately before the measurement.

### Measurement of Volume Change Rate

The volume change rate of an aluminum laminated film package or aluminum pouch package in which each of the compositions of the Examples and Comparative Examples was hermetically packaged was evaluated. The volume change rate was calculated by dividing the volume of the aluminum laminated film package or aluminum pouch package after a certain period of time by the volume of the aluminum laminated film package or aluminum pouch package before the start of the test, with the volume of the aluminum laminated film package or aluminum pouch package before the start of the test set as 100%. The volume was measured by immersing the sealed aluminum laminated film package or aluminum pouch package in water measured in a measuring cylinder, and reading the volume of the rising water surface. A higher volume change rate over 100% means that the swelling of the aluminum laminated film package or aluminum pouch package is severer.

### Production Example 1

Production of Material Containing Halogen-Based Oxidizing Agent Having Coating Layer 1 (Hereinafter Also Referred to as “HOC1”) and Material Containing Halogen-Based Oxidizing Agent Having Coating Layer 1′ (Hereinafter Also Referred to as “HOC1′”)

As a compound to be used for forming the coating layer, sodium benzoate was dissolved in water to prepare a 30 wt % aqueous coating solution of sodium benzoate. Sodium dichloroisocyanurate powder was placed in a rolling granulator (DPZ-1, produced by As One Corporation), and the rolling granulator was rotated while heating at 60° C. The aqueous coating solution was sprayed over sodium dichloroisocyanurate flowing in the rolling granulator. When a predetermined amount of a coating layer had been formed, spraying was terminated, thus obtaining a material containing a halogen-based oxidizing agent having a coating layer 1 (HOC1).

The effective chlorine content of HOC1 was 43.7%, the percentage of the coating layer was 27.4 wt %, the water content was 2.90 wt %, and the average particle size was 855 μm.

In addition, a material containing a halogen-based oxidizing agent having a coating layer 1′ (HOC1′) was produced in the same manner as in HOC1. The effective chlorine content of HOC1′ was 44.9%, the percentage of the coating layer was 25.5 wt %, the water content was 2.90 wt %, and the average particle size was 812 μm. HOC1 was used in Test Examples 1, 7, and 8 provided below, and HOC1′ was used in Test Examples 5 and 6 provided below.

### Production Example 2

### Production of Material Containing Halogen-Based Oxidizing Agent Having Coating Layer 2 (Hereinafter Also Referred to as “HOC2”)

As a compound to be used for forming the coating layer, sodium decanoate was dissolved in water to prepare a 20 wt % aqueous coating solution of sodium decanoate. Sodium decanoate was prepared by neutralizing decanoic acid with sodium hydroxide. A material containing a halogen-based oxidizing agent having a coating layer 2 (HOC2) was obtained in the same manner as in Production Example 1 except that the aqueous sodium decanoate solution was used as the aqueous coating solution.

The effective chlorine content of HOC2 was 45.9%, the percentage of the coating layer was 24.0%, and the water content was 2.8%. The average particle size was 1474 μm.

### Production Example 3

### Production of Material Containing Oxygen-Based Oxidizing Agent Having Coating Layer 1 (Hereinafter Also Referred to as “OOC1”)

A material containing an oxygen-based oxidizing agent having a coating layer 1 (OOC1) was obtained in the same manner as in Production Example 1 except that an oxygen-based oxidizing agent containing a peroxysulfuric acid-sulfuric acid-pentapotassium salt (Oxone) was used in place of sodium dichloroisocyanurate.

The effective oxygen content of OOC1 was 3.67%, the percentage of the coating layer was 22.9 wt %, and the water content was 0.82 wt %. The average particle size was 692 μm.

### Production Example 4

### Production of Material Containing Oxygen-Based Oxidizing Agent Having Coating Layer 2 (Hereinafter Also Referred to as “OOC2”)

As a compound to be used for forming the coating layer, sodium heptanoate was dissolved in water to prepare a 20 wt % aqueous coating solution of sodium heptanoate. Sodium heptanoate was prepared by neutralizing heptanoic acid with sodium hydroxide. A material containing an oxygen-based oxidizing agent having a coating layer 2 (OOC2) was obtained in the same manner as in Production Example 3 except that the aqueous sodium heptanoate solution was used as the aqueous coating solution.

The effective oxygen content of OOC2 was 3.14%, the percentage of the coating layer was 33.7 wt %, and the water content was 0.99 wt %. The average particle size was 1264 μm.

### Test Example 1

### Test for Temperature Change Due to Water Contamination

### (1) Test Method

Compositions having the formulations shown in Table 1 (Comparative Examples 3 to 8) were prepared by changing the ratio of powders of sodium dichloroisocyanurate (SDIC) and Oxone (registered trademark) (OX), as an oxygen-based oxidizing agent containing a peroxysulfuric acid-sulfuric acid-pentapotassium salt, so that the total weight was 50 g. In addition, powder of SDIC alone (Comparative Example 2), powder of OX alone (Comparative Example 1), and powder of the material containing a halogen-based oxidizing agent having a coating layer 1 (HOC1) alone (Comparative Example 9) were also prepared (Table 1).

The numerical values of the effective chlorine amount (ACL) (g) in Table 1 were calculated by multiplying the content (g) of the chlorine-based oxidizing agent or material containing a chlorine-based oxidizing agent in the composition by the effective chlorine content (%) of the chlorine-based oxidizing agent or material containing a chlorine-based oxidizing agent calculated by Equation 1. Similarly, the numerical values of the effective oxygen amount (AO) (g) in Table 1 were calculated by multiplying the content (g) of the oxygen-based oxidizing agent or material containing an oxygen-based oxidizing agent in the composition by the effective oxygen content (%) of the oxygen-based oxidizing agent or material containing an oxygen-based oxidizing agent calculated by Equation 4. The same applies to Tables 3, 5, 7, 9, and 11.

Each composition was placed in a 100 mL beaker, a glass thermometer with a 100° C. scale was inserted at the center of the composition, 5 mL of pure water was added around the thermometer, and the change in temperature over time near the location where the water was added was measured.

In the above compositions of SDIC and OX, the material containing a halogen-based oxidizing agent having a coating layer 1 (HOC1) was used in place of SDIC to prepare compositions of HOC1 and OX having the formulations shown in Table 1 (Examples 1 to 6). The amounts of the compositions of Examples 1 to 6 were adjusted so that the effective chlorine amount (ACL) (g) of SDIC contained in the compositions of Comparative Examples 3 to 8 and that of HOC1 contained in the compositions of Examples 1 to 6 were approximately equivalent. (The effective chlorine content (%) of SDIC was 62.7%, and the effective chlorine content (%) of HOC1 was 43.7%. Same below.) For these samples, the change in temperature over time when water was added was also measured in the same manner as described above.

In all of the following tests for temperature change due to water contamination, the air temperature during the test was 23 to 27° C., and the water temperature before the supply of the pure water used was 22 to 26° C. These conditions allow for a significant comparison of the temperature change measurement results of the compositions.

### (2) Results and Discussion

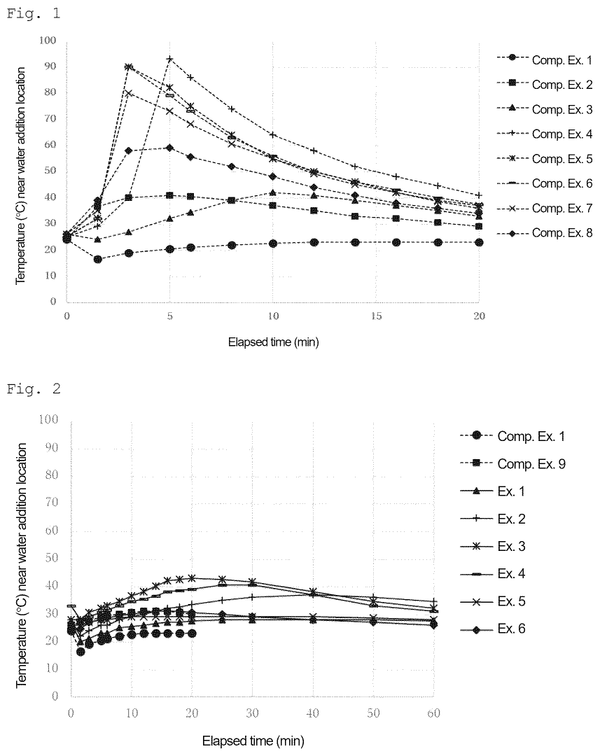

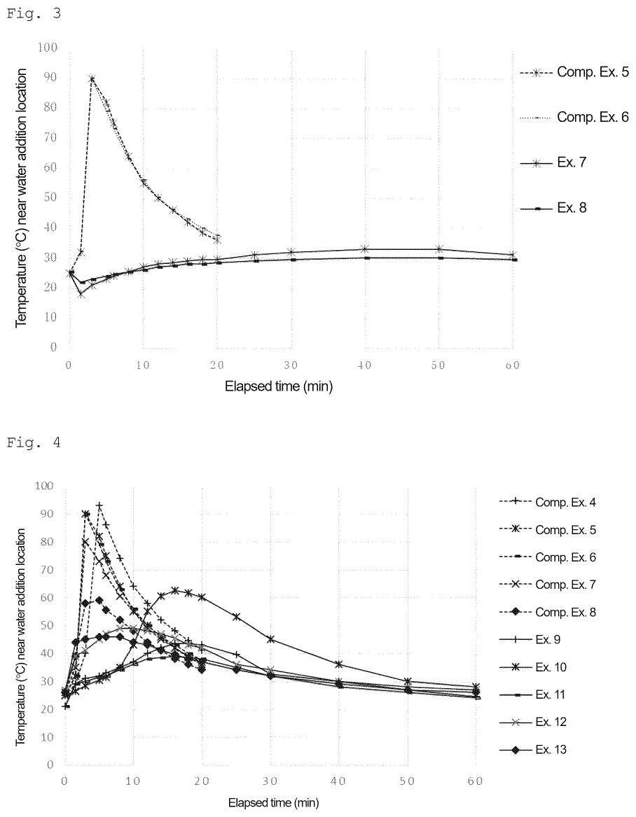

The test results are shown in Table 2 and FIGS. 1 and 2.

FIG. 1 shows that when water was added to the powder of SDIC alone (Comparative Example 2), heat was generated, and the temperature rose to a maximum of 41° C. (after 5 minutes). When water was added to the powder of OX alone (Comparative Example 1), heat was absorbed, and the temperature decreased to 16.5° C. (after 1.5 minutes). When water was added to the powder of HOC1 alone (Comparative Example 9), slight heat was generated, and the temperature rose to 31° C. (after 12 to 16 minutes).

In the case of the compositions of SDIC and OX (Comparative Examples 3 to 8), the temperature rose rapidly within 5 minutes after water was added. In particular, the compositions of Comparative Example 4 (SDIC: 20 g/OX: 30 g), Comparative Example 5 (SDIC: 22.7 g/OX: 27.3 g), and Comparative Example 6 (SDIC: 25 g/OX: 25 g) generated intense heat, and in the case of Comparative Example 4 (SDIC: 20 g/OX: 30 g), the temperature rose to a maximum of 93° C. after 5 minutes.

In the case of the compositions of HOC1 and OX (Examples 1 to 6), which are embodiments of the present invention, the temperature was measured for 60 minutes after water was added (Table 2 and FIG. 2); however, no noticeable exothermic peak was observed. The case with the highest temperature was Example 3 (HOC1: 32.6 g/OX: 27.3 g), in which the temperature gradually rose to 43° C. 20 minutes after water was added, but then slowly decreased.

Therefore, it was found that when the amount of water added was 5 mL, the compositions of HOC1 and OX (Examples 1 to 6) could inhibit heat generation more dramatically than the compositions of SDIC and OX (Comparative Examples 3 to 8).

TABLE 1

| | | | | Effective | Effective |
|---|---|---|---|---|---|
| | Components of | | | chlorine | oxygen |
| | composition (g) | | | amount (g) | amount (g) |
| | SDIC | HOC1 | OXONE | ACL | AO |
| Comp. Ex. 1 | — | — | 50 | — | 2.41 |
| Comp. Ex. 2 | 50 | — | — | 31.4 | — |
| Comp. Ex. 3 | 10 | — | 40 | 6.27 | 1.92 |
| Comp. Ex. 4 | 20 | — | 30 | 12.5 | 1.44 |
| Comp. Ex. 5 | 22.7 | — | 27.3 | 14.2 | 1.31 |
| Comp. Ex. 6 | 25 | — | 25 | 15.7 | 1.20 |
| Comp. Ex. 7 | 30 | — | 20 | 18.8 | 0.96 |
| Comp. Ex. 8 | 40 | — | 10 | 25.1 | 0.48 |
| Comp. Ex. 9 | — | 71.8 | — | 31.4 | — |
| Ex. 1 | — | 14.4 | 40 | 6.27 | 1.92 |
| Ex. 2 | — | 28.7 | 30 | 12.5 | 1.44 |
| Ex. 3 | — | 32.6 | 27.3 | 14.2 | 1.31 |
| Ex. 4 | — | 35.9 | 25 | 15.7 | 1.20 |
| Ex. 5 | — | 43.1 | 20 | 18.8 | 0.96 |
| Ex. 6 | — | 57.4 | 10 | 25.1 | 0.48 |

TABLE 2

| | | Water | Temperature (° C.) near water addition location | | | | | | | | | | | | | | | | |
|---|---|---|---|---|---|---|---|---|---|---|---|---|---|---|---|---|---|---|---|
| | | temp. | Imme- | | | | | | | | | | | | | | | | |
| | Air | (° C.) | diately | 1.5 | 3 | 5 | 6 | 8 | 10 | 12 | 14 | 16 | 18 | 20 | 25 | 30 | 40 | 50 | 60 |
| | temp. | Before | after | min | min | min | min | min | min | min | min | min | min | min | min | min | min | min | min |
| | (° C.) | addition | addition | later | later | later | later | later | later | later | later | later | later | later | later | later | later | later | later |
| Comp. | 26 | 24 | 24 | 16.5 | 19 | 20.5 | 21 | 22 | 22.5 | 23 | 23 | 23 | 23 | 23 | — | — | — | — | — |
| Ex. 1 | | | | | | | | | | | | | | | | | | | |
| Comp. | 23 | 22 | 24 | 36.5 | 40 | 41 | 40.5 | 39 | 37 | 35 | 33 | 32 | 30.5 | 29 | — | — | — | — | — |
| Ex. 2 | | | | | | | | | | | | | | | | | | | |
| Comp. | 23 | 22 | 26 | 24 | 27 | 32 | 34.5 | 39 | 42 | 41 | 39 | 37 | 35 | 33 | — | — | — | — | — |
| Ex. 3 | | | | | | | | | | | | | | | | | | | |
| Comp. | 24 | 23 | 25 | 29 | 40 | 93 | 86 | 74 | 64 | 58 | 52 | 48 | 44.5 | 41 | — | — | — | — | — |
| Ex. 4 | | | | | | | | | | | | | | | | | | | |
| Comp. | 24 | 23 | 25 | 32 | 90 | 82 | 75 | 64 | 55 | 50 | 46 | 42 | 38.5 | 36 | — | — | — | — | — |
| Ex. 5 | | | | | | | | | | | | | | | | | | | |
| Comp. | 24 | 22.5 | 25 | 32 | 90 | 79 | 73 | 63 | 56 | 50 | 46 | 43 | 40 | 37.5 | — | — | — | — | — |
| Ex. 6 | | | | | | | | | | | | | | | | | | | |
| Comp. | 24 | 22.5 | 26 | 35 | 80 | 73 | 68 | 60.5 | 55 | 49 | 45 | 42 | 39 | 37 | — | — | — | — | — |
| Ex. 7 | | | | | | | | | | | | | | | | | | | |
| Comp. | 24 | 22.5 | 26 | 39 | 58 | 59 | 55.5 | 52 | 48 | 44 | 41 | 38 | 36 | 34 | — | — | — | — | — |
| Ex. 8 | | | | | | | | | | | | | | | | | | | |
| Comp. | 26 | 24 | 26 | 27 | 27.5 | 29 | 29.5 | 30 | 30.5 | 31 | 31 | 31 | 30.5 | 30 | — | — | — | — | — |
| Ex. 9 | | | | | | | | | | | | | | | | | | | |
| Ex. 1 | 26.5 | 24 | 27 | 20 | 21 | 23 | 23 | 25 | 25.5 | 26 | 26.5 | 27 | 27 | 27.5 | 28 | 28 | 28 | 28 | 27.5 |
| Ex. 2 | 26.5 | 24 | 28 | 22 | 24 | 26 | 26 | 28 | 29 | 30 | 31 | 32 | 32.5 | 33.5 | 35 | 36 | 37 | 36 | 34.5 |
| Ex. 3 | 27 | 26 | 28 | 28 | 30.5 | 32 | 33 | 34.5 | 36.5 | 38 | 40 | 42 | 42.5 | 43 | 42.5 | 41.5 | 38 | 34.5 | 32 |
| Ex. 4 | 27 | 26 | 33 | 28 | 29 | 30.5 | 31.5 | 33 | 34.5 | 35.5 | 36.5 | 38 | 38.5 | 39 | 40.5 | 40.5 | 37 | 33 | 31 |
| Ex. 5 | 23 | 22 | 26 | 26 | 27 | 28 | 28 | 28.5 | 29 | 29 | 29 | 29 | 29 | 29 | 29 | 29 | 29 | 28.5 | 28 |
| Ex. 6 | 23 | 22 | 24.5 | 24.5 | 27 | 28 | 28.5 | 29.5 | 30 | 30.5 | 31 | 31 | 31 | 30.5 | 30 | 29 | 28 | 27 | 26 |

### Test Example 2

### Test for Temperature Change Due to Water Contamination

### (1) Test Method

Compositions of HOC2 and OX having the formulations shown in Table 3 (Examples 7 and 8) were prepared in the same manner as in Test Example 1 except that the material containing a halogen-based oxidizing agent having a coating layer 2 (HOC2) was used. The amounts of the compositions of Examples 7 and 8 were adjusted so that the effective chlorine amount (ACL) (g) of SDIC contained in the compositions of Comparative Examples 5 and 6 and that of HOC2 contained in the compositions of Examples 7 and 8 were approximately equivalent. (The effective chlorine content (%) of SDIC was 62.7%, and the effective chlorine content (%) of HOC2 was 45.9%. Same below.) For these samples, the change in temperature over time when water was added was also measured in the same manner as described above. As Comparative Example 10, a test was also conducted with HOC2 alone.

### (2) Results and Discussion

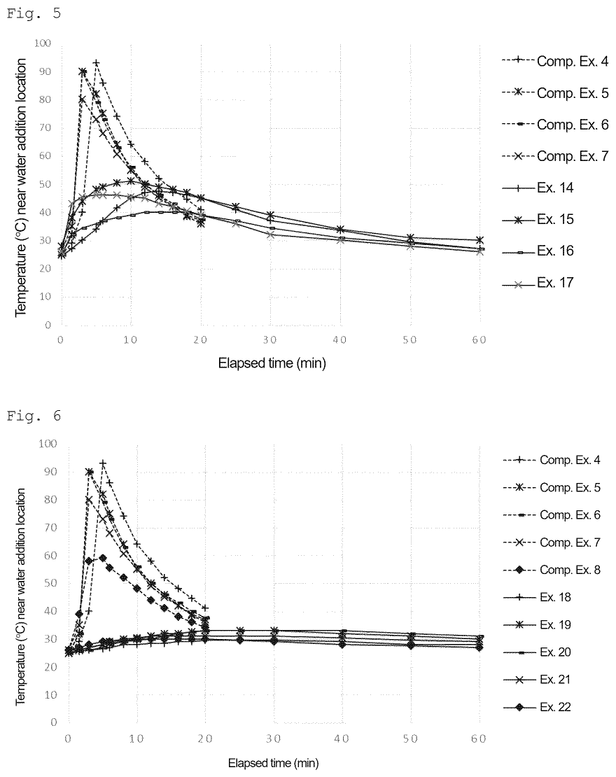

The test results are shown in Table 4 and FIG. 3.

When water was added to the powder of SDIC alone (Comparative Example 2) and when water was added to the powder of OX alone (Comparative Example 1), the results were the same as those in Test Example 1; however, when water was added to the powder of HOC2 alone (Comparative Example 10), the temperature rose slightly to 26.5° C. (after 12 to 20 minutes).

The results of the compositions of SDIC and OX (Comparative Examples 5 and 6) were the same as those in Test Example 1. The compositions of Comparative Example 5 (SDIC: 22.7 g/OX: 27.3 g) and Comparative Example 6 (SDIC: 25 g/OX: 25 g) generated intense heat, and the temperature rose to a maximum of 90° C. after 3 minutes. On the other hand, in the case of the compositions of HOC2 and OX (Examples 7 and 8), which are embodiments of the present invention, the temperature was measured for 60 minutes after water was added (Table 4 and FIG. 3); however, no noticeable exothermic peak was observed. The case with the highest temperature was Example 8 (HOC2: 34.2 g/OX: 27.3 g), in which the temperature gradually rose to 33° C. 40 minutes after water was added, but then slowly decreased.

Therefore, it was found that when the amount of water added was 5 mL, the compositions of HOC2 and OX (Examples 7 and 8) could inhibit heat generation more dramatically than the compositions of SDIC and OX (Comparative Examples 5 and 6).

TABLE 3

| | | | | Effective | Effective |
|---|---|---|---|---|---|
| | Components of | | | chlorine | oxygen |
| | composition (g) | | | amount (g) | amount (g) |
| | SDIC | HOC2 | OXONE | ACL | AO |
| Comp. Ex. 2 | 50 | — | — | 31.4 | — |
| Comp. Ex. 5 | 22.7 | — | 27.3 | 14.2 | 1.31 |
| Comp. Ex. 6 | 25 | — | 25 | 15.7 | 1.20 |
| Comp. Ex. 10 | — | 68.4 | — | 31.4 | — |
| Ex. 7 | — | 31.0 | 27.3 | 14.2 | 1.31 |
| Ex. 8 | — | 34.2 | 25 | 15.7 | 1.20 |

TABLE 4

| | | Water | Temperature (° C.) near water addition location | | | | | | | | | | | | | | | | |
|---|---|---|---|---|---|---|---|---|---|---|---|---|---|---|---|---|---|---|---|
| | | temp. | Imme- | | | | | | | | | | | | | | | | |
| | Air | (° C.) | diately | 1.5 | 3 | 5 | 6 | 8 | 10 | 12 | 14 | 16 | 18 | 20 | 25 | 30 | 40 | 50 | 60 |
| | temp. | Before | after | min | min | min | min | min | min | min | min | min | min | min | min | min | min | min | min |
| | (° C.) | addition | addition | later | later | later | later | later | later | later | later | later | later | later | later | later | later | later | later |
| Comp. | 26 | 24 | 24 | 16.5 | 19 | 20.5 | 21 | 22 | 22.5 | 23 | 23 | 23 | 23 | 23 | — | — | — | — | — |
| Ex. 1 | | | | | | | | | | | | | | | | | | | |
| Comp. | 23 | 22 | 24 | 36.5 | 40 | 41 | 40.5 | 39 | 37 | 35 | 33 | 32 | 30.5 | 29 | — | — | — | — | — |
| Ex. 2 | | | | | | | | | | | | | | | | | | | |
| Comp. | 24 | 23 | 25 | 32 | 90 | 82 | 75 | 64 | 55 | 50 | 46 | 42 | 38.5 | 36 | — | — | — | — | — |
| Ex. 5 | | | | | | | | | | | | | | | | | | | |
| Comp. | 24 | 22.5 | 25 | 32 | 90 | 79 | 73 | 63 | 56 | 50 | 46 | 43 | 40 | 37.5 | — | — | — | — | — |
| Ex. 6 | | | | | | | | | | | | | | | | | | | |
| Comp. | 25 | 24 | 24.5 | 22 | 23 | 25 | 25 | 26 | 26 | 26.5 | 26.5 | 26.5 | 26.5 | 26.5 | 26 | 26 | 25.5 | 25 | 25 |
| Ex. 10 | | | | | | | | | | | | | | | | | | | |
| Ex. 7 | 25 | 24 | 25.5 | 2 | 23 | 24 | 24.5 | 25.5 | 26 | 27 | 27.5 | 28 | 28 | 28.5 | 29 | 29.5 | 30 | 30 | 29.5 |
| Ex. 8 | 24 | 24 | 25 | 18 | 21 | 23 | 24 | 25.5 | 27 | 28 | 28.5 | 29 | 29.5 | 29.5 | 31 | 32 | 33 | 33 | 31 |

### Test Example 3

### Test for Temperature Change Due to Water Contamination

### (1) Test Method

Using the material containing an oxygen-based oxidizing agent having a coating layer 1 (OOC1), compositions of SDIC and OOC1 having the formulations shown in Table 5 (Examples 9 to 13) were prepared in the same manner as in Test Example 1. The amounts of the compositions of Examples 9 to 13 were adjusted so that the effective oxygen amount (AO) (g) of OX contained in the compositions of Comparative Examples 4 to 8 and that of OOC1 contained in the compositions of Examples 9 to 13 were approximately equivalent. (The effective oxygen content (%) of OX was 4.81%, and the effective oxygen content (%) of OOC1 was 3.67%. Same below.) For these samples, the change in temperature over time when water was added was also measured in the same manner as described above. As Comparative Example 11, a test was also conducted with OOC1 alone.

### (2) Results and Discussion

The test results are shown in Table 6 and FIG. 4.

When water was added to the powder of SDIC alone (Comparative Example 2) and when water was added to the powder of OX alone (Comparative Example 1), the results were the same as those in Test Example 1; however, when water was added to the powder of OOC1 alone (Comparative Example 11), the temperature rose slightly to 32° C. (after 12 to 20 minutes).

The results of the compositions of SDIC and OX (Comparative Examples 4 to 8) were the same as those in Test Example 1. The compositions of Comparative Example 4 (SDIC: 20 g/OX: 30 g), Comparative Example 5 (SDIC: 22.7 g/OX: 27.3 g), and Comparative Example 6 (SDIC: 25 g/OX: 25 g) generated intense heat, and the temperature rose to a maximum of 90 to 93° C. after 3 to 5 minutes. On the other hand, in the case of the compositions of SDIC and OOC1 (Examples 9 to 13), which are embodiments of the present invention, the temperature was measured for 60 minutes after water was added (Table 6 and FIG. 4). The case with the highest temperature was Example 10 (SDIC: 22.7 g/OOC1: 35.8 g), in which the temperature gradually rose to 62.5° C. 16 minutes after water was added, but then slowly decreased.

Therefore, it was found that when the amount of water added was 5 mL, the compositions of SDIC and OOC1 (Examples 9 to 13) could inhibit heat generation more effectively than the compositions of SDIC and OX (Comparative Examples 4 to 8).

TABLE 5

| | | | | Effective | Effective |
|---|---|---|---|---|---|
| | Components of | | | chlorine | oxygen |
| | composition (g) | | | amount (g) | amount (g) |
| | SDIC | OXONE | OOC1 | ACL | AO |
| Comp. Ex. 1 | — | 50 | — | — | 2.41 |
| Comp. Ex. 2 | 50 | — | — | 31.4 | — |
| Comp. Ex. 4 | 20 | 30 | — | 12.5 | 1.44 |
| Comp. Ex. 5 | 22.7 | 27.3 | — | 14.2 | 1.31 |
| Comp. Ex. 6 | 25 | 25 | — | 15.7 | 1.20 |
| Comp. Ex. 7 | 30 | 20 | — | 18.8 | 0.96 |
| Comp. Ex. 8 | 40 | 10 | — | 25.1 | 0.48 |
| Comp. Ex. 11 | — | — | 65.5 | — | 2.40 |
| Ex. 9 | 20 | — | 39.3 | 12.5 | 1.44 |
| Ex. 10 | 22.7 | — | 35.8 | 14.2 | 1.31 |
| Ex. 11 | 25 | — | 32.7 | 15.7 | 1.20 |
| Ex. 12 | 30 | — | 27.0 | 18.8 | 0.99 |
| Ex. 13 | 40 | — | 13.5 | 25.1 | 0.50 |

TABLE 6

| | | Water | Temperature (° C.) near water addition location | | | | | | | | | | | | | | | | |
|---|---|---|---|---|---|---|---|---|---|---|---|---|---|---|---|---|---|---|---|
| | | temp. | Imme- | | | | | | | | | | | | | | | | |
| | Air | (° C.) | diately | 1.5 | 3 | 5 | 6 | 8 | 10 | 12 | 14 | 16 | 18 | 20 | 25 | 30 | 40 | 50 | 60 |
| | temp. | Before | after | min | min | min | min | min | min | min | min | min | min | min | min | min | min | min | min |
| | (° C.) | addition | addition | later | later | later | later | later | later | later | later | later | later | later | later | later | later | later | later |
| Comp. | 26 | 24 | 24 | 16.5 | 19 | 20.5 | 21 | 22 | 22.5 | 23 | 23 | 23 | 23 | 23 | — | — | — | — | — |
| Ex. 1 | | | | | | | | | | | | | | | | | | | |
| Comp. | 23 | 22 | 24 | 36.5 | 40 | 41 | 40.5 | 39 | 37 | 35 | 33 | 32 | 30.5 | 29 | — | — | — | — | — |
| Ex. 2 | | | | | | | | | | | | | | | | | | | |
| Comp. | 24 | 23 | 25 | 29 | 40 | 93 | 86 | 74 | 64 | 58 | 52 | 48 | 44.5 | 41 | — | — | — | — | — |
| Ex. 4 | | | | | | | | | | | | | | | | | | | |
| Comp. | 24 | 23 | 25 | 32 | 90 | 82 | 75 | 64 | 55 | 50 | 46 | 42 | 38.5 | 36 | — | — | — | — | — |
| Ex. 5 | | | | | | | | | | | | | | | | | | | |
| Comp. | 24 | 22.5 | 25 | 32 | 90 | 79 | 73 | 63 | 56 | 50 | 46 | 43 | 40 | 37.5 | — | — | — | — | — |
| Ex. 6 | | | | | | | | | | | | | | | | | | | |
| Comp. | 24 | 22.5 | 26 | 35 | 80 | 73 | 68 | 60.5 | 55 | 49 | 45 | 42 | 39 | 37 | — | — | — | — | — |
| Ex. 7 | | | | | | | | | | | | | | | | | | | |
| Comp | 24 | 22.5 | 26 | 39 | 58 | 59 | 55.5 | 52 | 48 | 44 | 41 | 38 | 36 | 34 | — | — | — | — | — |
| Ex. 8 | | | | | | | | | | | | | | | | | | | |
| Comp. | 25 | 23 | 25 | 24.5 | 25 | 27 | 28 | 30 | 31 | 32 | 32 | 32 | 32 | 32 | 31 | 30.5 | 29 | 28 | 27.5 |
| Ex. 11 | | | | | | | | | | | | | | | | | | | |
| Ex. 9 | 20 | 19.5 | 21 | 29 | 31 | 32 | 33 | 35 | 37 | 40 | 42 | 43.5 | 43.5 | 43 | 39.5 | 32.5 | 30 | 27 | 24.5 |
| Ex. 10 | 25 | 23 | 25 | 26.5 | 28.5 | 30.5 | 31.5 | 35 | 43 | 55 | 60.5 | 62.5 | 61.5 | 60 | 53 | 45 | 36 | 30 | 28 |
| Ex. 11 | 20 | 19.5 | 21 | 29 | 30 | 31.5 | 32 | 34 | 36 | 38 | 38.5 | 39 | 38.5 | 38 | 35 | 32 | 28 | 26 | 24 |
| Ex. 12 | 26 | 23.5 | 27 | 39 | 41 | 45 | 47 | 49 | 49 | 48 | 47 | 45.5 | 43 | 42 | 36 | 34 | 30 | 28 | 27 |
| Ex. 13 | 26 | 23.5 | 26 | 44 | 45 | 46 | 46 | 46 | 44 | 43 | 41 | 39.5 | 38 | 37 | 34 | 32 | 29 | 27 | 26 |

### Test Example 4

### Test for Temperature Change Due to Water Contamination

### (1) Test Method

Using the material containing an oxygen-based oxidizing agent having a coating layer 2 (OOC2), compositions of SDIC and OOC2 having the formulations shown in Table 7 (Examples 14 to 17) were prepared in the same manner as in Test Example 3. The amounts of the compositions of Examples 14 to 17 were adjusted so that the effective oxygen amount (AO) (g) of OX contained in the compositions of Comparative Examples 4 to 7 and that of OOC2 contained in the compositions of Examples 14 to 17 were approximately equivalent. (The effective oxygen content (%) of OX was 4.81%, and the effective oxygen content (%) of OOC2 was 3.14%. Same below.) For these samples, the change in temperature over time when water was added was also measured in the same manner as in Test Examples 1 to 3. As Comparative Example 12, a test was also conducted with OOC2 alone.

### (2) Results and Discussion

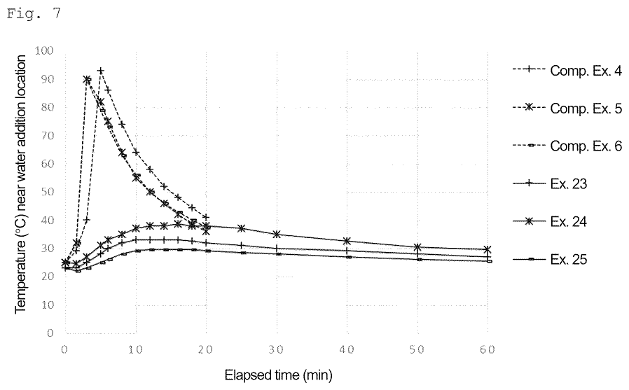

The test results are shown in Table 8 and FIG. 5.

When water was added to the powder of SDIC alone (Comparative Example 2) and when water was added to the powder of OX alone (Comparative Example 1), the results were the same as those in Test Example 1; however, when water was added to the powder of OOC2 alone (Comparative Example 12), the temperature rose slightly to 31° C. (after 14 to 40 minutes).

The results of the compositions of SDIC and OX (Comparative Examples 4 to 7) were the same as those in Test Example 1. The compositions of Comparative Example 4 (SDIC: 20 g/OX: 30 g), Comparative Example 5 (SDIC: 22.7 g/OX: 27.3 g), and Comparative Example 6 (SDIC: 25 g/OX: 25 g) generated intense heat, and the temperature rose to a maximum of 90 to 93° C. after 3 to 5 minutes. On the other hand, in the case of the compositions of SDIC and OOC2 (Examples 14 to 17), which are embodiments of the present invention, the temperature was measured for 60 minutes after water was added (Table 8 and FIG. 5). The case with the highest temperature was Example 15 (SDIC: 22.7 g/OOC2: 41.8 g), in which the temperature gradually rose to 51° C. 10 minutes after water was added, but then slowly decreased.

Therefore, it was found that when the amount of water added was 5 mL, the compositions of SDIC and OOC2 (Examples 14 to 17) could inhibit heat generation more effectively than the compositions of SDIC and OX (Comparative Examples 4 to 7).

TABLE 7

| | | | | Effective | Effective |
|---|---|---|---|---|---|
| | Components of | | | chlorine | oxygen |
| | composition (g) | | | amount (g) | amount (g) |
| | SDIC | OXONE | OOC2 | ACL | AO |
| Comp. Ex. 1 | — | 50 | — | — | 2.41 |
| Comp. Ex. 2 | 50 | — | — | 31.4 | — |
| Comp. Ex. 4 | 20 | 30 | — | 12.5 | 1.44 |
| Comp. Ex. 5 | 22.7 | 27.3 | — | 14.2 | 1.31 |
| Comp. Ex. 6 | 25 | 25 | — | 15.7 | 1.20 |
| Comp. Ex. 7 | 30 | 20 | — | 18.8 | 0.96 |
| Comp. Ex. 12 | — | — | 76.6 | — | 2.41 |
| Ex. 14 | 20 | — | 45.9 | 12.5 | 1.44 |
| Ex. 15 | 22.7 | — | 41.8 | 14.2 | 1.31 |
| Ex. 16 | 25 | — | 38.3 | 15.7 | 1.20 |
| Ex. 17 | 30 | — | 30.6 | 18.8 | 0.96 |

TABLE 8

| | | Water | Temperature (° C.) near water addition location | | | | | | | | | | | | | | | | |
|---|---|---|---|---|---|---|---|---|---|---|---|---|---|---|---|---|---|---|---|
| | | temp. | Imme- | | | | | | | | | | | | | | | | |
| | Air | (° C.) | diately | 1.5 | 3 | 5 | 6 | 8 | 10 | 12 | 14 | 16 | 18 | 20 | 25 | 30 | 40 | 50 | 60 |
| | temp. | Before | after | min | min | min | min | min | min | min | min | min | min | min | min | min | min | min | min |
| | (° C.) | addition | addition | later | later | later | later | later | later | later | later | later | later | later | later | later | later | later | later |
| Comp. | 26 | 24 | 24 | 16.5 | 19 | 20.5 | 21 | 22 | 22.5 | 23 | 23 | 23 | 23 | 23 | — | — | — | — | — |
| Ex. 1 | | | | | | | | | | | | | | | | | | | |
| Comp. | 23 | 22 | 24 | 36.5 | 40 | 41 | 40.5 | 39 | 37 | 35 | 33 | 32 | 30.5 | 29 | — | — | — | — | — |
| Ex. 2 | | | | | | | | | | | | | | | | | | | |
| Comp. | 24 | 23 | 25 | 29 | 40 | 93 | 86 | 74 | 64 | 58 | 52 | 48 | 44.5 | 41 | — | — | — | — | — |
| Ex. 4 | | | | | | | | | | | | | | | | | | | |
| Comp. | 24 | 23 | 25 | 32 | 90 | 82 | 75 | 64 | 55 | 50 | 46 | 42 | 38.5 | 36 | — | — | — | — | — |
| Ex. 5 | | | | | | | | | | | | | | | | | | | |
| Comp. | 24 | 22.5 | 25 | 32 | 90 | 79 | 73 | 63 | 56 | 50 | 46 | 43 | 40 | 37.5 | — | — | — | — | — |
| Ex. 6 | | | | | | | | | | | | | | | | | | | |
| Comp. | 24 | 22.5 | 26 | 35 | 80 | 73 | 68 | 60.5 | 55 | 49 | 45 | 42 | 39 | 37 | — | — | — | — | — |
| Ex. 7 | | | | | | | | | | | | | | | | | | | |
| Comp. | 26 | 24 | 26 | 22 | 25 | 28 | 28.5 | 30 | 30.5 | 30.5 | 31 | 31 | 31 | 31 | 31 | 31 | 31 | 30.5 | 30 |
| Ex. 12 | | | | | | | | | | | | | | | | | | | |
| Ex. 14 | 23 | 20.5 | 24.5 | 27 | 30 | 34 | 37 | 41.5 | 45 | 47 | 47.5 | 47 | 46 | 45 | 41 | 37 | 33.5 | 29.5 | 27 |
| Ex. 15 | 26 | 24 | 28 | 38 | 44 | 48 | 49 | 50.5 | 51 | 50 | 49 | 48 | 47 | 45 | 42 | 39 | 34 | 31 | 30 |
| Ex. 16 | 23 | 20.5 | 25 | 32 | 34.5 | 36 | 37 | 38 | 39 | 40 | 40 | 40 | 40 | 39 | 37 | 34.5 | 31 | 29 | 27 |
| Ex. 17 | 26 | 23 | 26 | 43 | 45.5 | 46 | 46 | 46 | 45.5 | 45 | 43 | 42 | 40.5 | 39 | 36 | 32 | 30 | 28 | 26 |

### Test Example 5

### Test for Temperature Change Due to Water Contamination

### (1) Test Method

Using HOC1′ and OOC1, compositions of HOC1′ and OOC1 having the formulations shown in Table 9 (Examples 18 to 22) were prepared in the same manner as in Test Examples 1 to 4. The amounts of the compositions of Examples 18 to 22 were adjusted so that the effective chlorine amount (ACL) (g) and effective oxygen amount (AO) (g) of SDIC and OX contained in the compositions of Comparative Examples 4 to 7 and those of HOC1′ and OOC1 contained in the compositions of Examples 18 to 22 were approximately equivalent. For these samples, the change in temperature over time when water was added was also measured in the same manner as in Test Examples 1 to 4.

### (2) Results and Discussion

The test results are shown in Table 10 and FIG. 6.

When water was added to the powder of SDIC alone (Comparative Example 2) and when water was added to the powder of OX alone (Comparative Example 1), the results were the same as those in Test Example 1. When water was added to the powder of HOC1 alone (Comparative Example 9) and when water was added to the powder of OOC1 alone (Comparative Example 11), the results were the same as those in Test Examples 1 and 3, respectively.

The results of the compositions of SDIC and OX (Comparative Examples 4 to 7) were the same as those in Test Example 1. The compositions of Comparative Example 4 (SDIC: 20 g/OX: 30 g), Comparative Example 5 (SDIC: 22.7 g/OX: 27.3 g), and Comparative Example 6 (SDIC: 25 g/OX: 25 g) generated intense heat, and the temperature rose to a maximum of 90 to 93° C. after 3 to 5 minutes. On the other hand, in the case of the compositions of HOC1′ and OOC1 (Examples 18 to 22), which are embodiments of the present invention, the temperature was measured for 60 minutes after water was added (Table 10 and FIG. 6); however, no noticeable exothermic peak was observed. The case with the highest temperature was Example 19 (HOC1′: 31.7 g/OOC1: 35.8 g) and Example 20 (HOC1′: 34.9 g/OOC1: 32.7 g), in which the temperature gradually rose to 33° C. 20 minutes after water was added, but then slowly decreased.

Therefore, it was found that when the amount of water added was 5 mL, the compositions of HOC1′ and OOC1 (Examples 18 to 22) could inhibit heat generation more dramatically than the compositions of SDIC and OX (Comparative Examples 4 to 7).

TABLE 9

| | | | | | Effective | Effective |
|---|---|---|---|---|---|---|
| | Components of composition (g) | | | | chlorine | oxygen |
| | | HOC1 or | | | amount (g) | amount (g) |
| | SDIC | HOC1′ | OXONE | OOC1 | ACL | AO |
| Comp. Ex. 1 | — | — | 50 | — | — | 2.41 |
| Comp. Ex. 2 | 50 | — | — | — | 31.4 | — |
| Comp. Ex. 4 | 20 | — | 30 | — | 12.5 | 1.44 |
| Comp. Ex. 5 | 22.7 | — | 27.3 | — | 14.2 | 1.31 |
| Comp. Ex. 6 | 25 | — | 25 | — | 15.7 | 1.20 |
| Comp. Ex. 7 | 30 | — | 20 | — | 18.8 | 0.96 |
| Comp. Ex. 8 | 40 | — | 10 | — | 25.1 | 0.48 |
| Comp. Ex. 9 | — | 71.8 | — | — | 31.4 | — |
| Comp. Ex. 11 | — | — | — | 65.5 | — | 2.40 |
| Ex. 18 | — | 28.0 | — | 39.3 | 12.6 | 1.44 |
| Ex. 19 | — | 31.7 | — | 35.8 | 14.2 | 1.31 |
| Ex. 20 | — | 34.9 | — | 32.7 | 15.7 | 1.20 |
| Ex. 21 | — | 41.9 | — | 27 | 18.8 | 0.99 |
| Ex. 22 | — | 55.9 | — | 13.5 | 25.1 | 0.50 |

TABLE 10

| | | Water | Temperature (° C.) near water addition location | | | | | | | | | | | | | | | | |
|---|---|---|---|---|---|---|---|---|---|---|---|---|---|---|---|---|---|---|---|
| | | temp. | Imme- | | | | | | | | | | | | | | | | |
| | Air | (° C.) | diately | 1.5 | 3 | 5 | 6 | 8 | 10 | 12 | 14 | 16 | 18 | 20 | 25 | 30 | 40 | 50 | 60 |
| | temp. | Before | after | min | min | min | min | min | min | min | min | min | min | min | min | min | min | min | min |
| | (° C.) | addition | addition | later | later | later | later | later | later | later | later | later | later | later | later | later | later | later | later |
| Comp. | 26 | 24 | 24 | 16.5 | 19 | 20.5 | 21 | 22 | 22.5 | 23 | 23 | 23 | 23 | 23 | — | — | — | — | — |
| Ex. 1 | | | | | | | | | | | | | | | | | | | |
| Comp. | 23 | 22 | 24 | 36.5 | 40 | 41 | 40.5 | 39 | 37 | 35 | 33 | 32 | 30.5 | 29 | — | — | — | — | — |
| Ex. 2 | | | | | | | | | | | | | | | | | | | |
| Comp. | 24 | 23 | 25 | 29 | 40 | 93 | 86 | 74 | 64 | 58 | 52 | 48 | 44.5 | 41 | — | — | — | — | — |
| Ex. 4 | | | | | | | | | | | | | | | | | | | |
| Comp. | 24 | 23 | 25 | 32 | 90 | 82 | 75 | 64 | 55 | 50 | 46 | 42 | 38.5 | 36 | — | — | — | — | — |
| Ex. 5 | | | | | | | | | | | | | | | | | | | |
| Comp. | 24 | 22.5 | 25 | 32 | 90 | 79 | 73 | 63 | 56 | 50 | 46 | 43 | 40 | 37.5 | — | — | — | — | — |
| Ex. 6 | | | | | | | | | | | | | | | | | | | |
| Comp. | 24 | 22.5 | 26 | 35 | 80 | 73 | 68 | 60.5 | 55 | 49 | 45 | 42 | 39 | 37 | — | — | — | — | — |
| Ex. 7 | | | | | | | | | | | | | | | | | | | |
| Comp. | 24 | 22.5 | 26 | 39 | 58 | 59 | 55.5 | 52 | 48 | 44 | 41 | 38 | 36 | 34 | — | — | — | — | — |
| Ex. 8 | | | | | | | | | | | | | | | | | | | |
| Comp | 26 | 24 | 26 | 27 | 27.5 | 29 | 29.5 | 30 | 30.5 | 31 | 31 | 31 | 30.5 | 30 | — | — | — | — | — |
| Ex. 9 | | | | | | | | | | | | | | | | | | | |
| Comp. | 25 | 23 | 25 | 24.5 | 25 | 27 | 28 | 30 | 31 | 32 | 32 | 32 | 32 | 32 | 31 | 30.5 | 29 | 28 | 27.5 |
| Ex. 11 | | | | | | | | | | | | | | | | | | | |
| Ex. 18 | 25 | 23 | 25 | 25.5 | 26 | 26.5 | 27 | 28 | 28 | 28.5 | 28.5 | 29 | 29 | 29.5 | 29.5 | 29.5 | 29 | 28 | 28 |
| Ex. 19 | 23.5 | 23 | 25 | 26 | 27 | 28 | 29 | 30 | 30.5 | 31 | 32 | 32 | 32.5 | 33 | 33 | 33 | 32 | 31 | 30 |
| Ex. 20 | 25 | 23 | 25 | 25.5 | 26 | 27 | 28 | 29 | 29.5 | 30 | 31 | 32 | 32.5 | 33 | 33 | 33 | 33 | 32 | 31 |
| Ex. 21 | 25 | 24.5 | 26 | 26 | 27 | 28 | 28.5 | 29 | 30 | 31 | 31 | 31 | 31 | 31 | 31 | 31 | 30.5 | 29.5 | 29 |
| Ex. 22 | 25 | 24.5 | 26 | 27 | 28 | 29 | 29 | 29.5 | 30 | 30 | 30 | 30 | 30 | 30 | 29.5 | 29 | 28 | 27.5 | 27 |

### Test Example 6

### Test for Temperature Change Due to Water Contamination

### (1) Test Method

Using OOC2 in place of OOC1, compositions of HOC1′ and OOC2 having the formulations shown in Table 11 (Examples 23 to 25) were prepared in the same manner as in Test Example 5. The amounts of the compositions of Examples 23 to 25 were adjusted so that the effective chlorine amount (ACL) (g) and effective oxygen amount (AO) (g) of SDIC and OX contained in the compositions of Comparative Examples 4 to 6 and those of HOC1′ and OOC2 contained in the compositions of Examples 23 to 25 were approximately equivalent. For these samples, the change in temperature over time when water was added was also measured in the same manner as in Test Example 5.

### (2) Results and Discussion

The test results are shown in Table 12 and FIG. 7.

When water was added to the powder of SDIC alone (Comparative Example 2) and when water was added to the powder of OX alone (Comparative Example 1), the results were the same as those in Test Example 1. When water was added to the powder of HOC1 alone (Comparative Example 9) and when water was added to the powder of OOC2 alone (Comparative Example 12), the results were the same as those in Test Examples 1 and 4, respectively.

The results of the compositions of SDIC and OX (Comparative Examples 4 to 6) were the same as those in Test Example 1. The compositions of Comparative Example 4 (SDIC: 20 g/OX: 30 g), Comparative Example 5 (SDIC: 22.7 g/OX: 27.3 g), and Comparative Example 6 (SDIC: 25 g/OX: 25 g) generated intense heat, and the temperature rose to a maximum of 90 to 93° C. after 3 to 5 minutes. On the other hand, in the case of the compositions of HOC1′ and OOC2 (Examples 23 to 25), which are embodiments of the present invention, the temperature was measured for 60 minutes after water was added (Table 12 and FIG. 7). The case with the highest temperature was Example 24 (HOC1′: 31.7 g/OOC2: 41.8 g), in which the temperature gradually rose to 38.5° C. 18 minutes after water was added, but then slowly decreased.

Therefore, it was found that when the amount of water added was 5 mL, the compositions of HOC1′ and OOC2 (Examples 23 to 25) could inhibit heat generation more dramatically than the compositions of SDIC and OX (Comparative Examples 4 to 6).

TABLE 11

| | | | | | Effective | Effective |
|---|---|---|---|---|---|---|
| | Components of composition (g) | | | | chlorine | oxygen |
| | | HOC1 or | | | amount (g) | amount (g) |
| | SDIC | HOC1′ | OXONE | OOC2 | ACL | AO |
| Comp. Ex. 1 | — | — | 50 | — | — | 2.41 |
| Comp. Ex. 2 | 50 | — | — | — | 31.4 | — |
| Comp. Ex. 4 | 20 | — | 30 | — | 12.5 | 1.44 |
| Comp. Ex. 5 | 22.7 | — | 27.3 | — | 14.2 | 1.31 |
| Comp. Ex. 6 | 25 | — | 25 | — | 15.7 | 1.20 |
| Comp. Ex. 9 | — | 71.8 | — | — | 31.4 | — |
| Comp. Ex. 12 | — | — | — | 76.6 | — | 2.41 |
| Ex. 23 | — | 28.0 | — | 45.9 | 12.6 | 1.44 |
| Ex. 24 | — | 31.7 | — | 41.8 | 14.2 | 1.31 |
| Ex. 25 | — | 34.9 | — | 38.3 | 15.7 | 1.20 |

TABLE 12

| | | Water | Temperature (° C.) near water addition location | | | | | | | | | | | | | | | | |
|---|---|---|---|---|---|---|---|---|---|---|---|---|---|---|---|---|---|---|---|
| | | temp. | Imme- | | | | | | | | | | | | | | | | |
| | Air | (° C.) | diately | 1.5 | 3 | 5 | 6 | 8 | 10 | 12 | 14 | 16 | 18 | 20 | 25 | 30 | 40 | 50 | 60 |
| | temp. | Before | after | min | min | min | min | min | min | min | min | min | min | min | min | min | min | min | min |
| | (° C.) | addition | addition | later | later | later | later | later | later | later | later | later | later | later | later | later | later | later | later |
| Comp. | 26 | 24 | 24 | 16.5 | 19 | 20.5 | 21 | 22 | 22.5 | 23 | 23 | 23 | 23 | 23 | — | — | — | — | — |
| Ex. 1 | | | | | | | | | | | | | | | | | | | |
| Comp. | 23 | 22 | 24 | 36.5 | 40 | 41 | 40.5 | 39 | 37 | 35 | 33 | 32 | 30.5 | 29 | — | — | — | — | — |
| Ex. 2 | | | | | | | | | | | | | | | | | | | |
| Comp. | 24 | 23 | 25 | 29 | 40 | 93 | 86 | 74 | 64 | 58 | 52 | 48 | 44.5 | 41 | — | — | — | — | — |
| Ex. 4 | | | | | | | | | | | | | | | | | | | |
| Comp. | 24 | 23 | 25 | 32 | 90 | 82 | 75 | 64 | 55 | 50 | 46 | 42 | 38.5 | 36 | — | — | — | — | — |
| Ex. 5 | | | | | | | | | | | | | | | | | | | |
| Comp. | 24 | 22.5 | 25 | 32 | 90 | 79 | 73 | 63 | 56 | 50 | 46 | 43 | 40 | 37.5 | — | — | — | — | — |
| Ex. 6 | | | | | | | | | | | | | | | | | | | |
| Comp. | 26 | 24 | 26 | 27 | 27.5 | 29 | 29.5 | 30 | 30.5 | 31 | 31 | 31 | 30.5 | 30 | — | — | — | — | — |
| Ex. 9 | | | | | | | | | | | | | | | | | | | |
| Comp. | 26 | 24 | 26 | 22 | 25 | 28 | 28.5 | 30 | 30.5 | 30.5 | 31 | 31 | 31 | 31 | 31 | 31 | 31 | 30.5 | 30 |
| Ex. 12 | | | | | | | | | | | | | | | | | | | |
| Ex. 23 | 22 | 21.5 | 23 | 23 | 25 | 28 | 30 | 32 | 33 | 33 | 33 | 33 | 32.5 | 32 | 31 | 30 | 29 | 28 | 27 |
| Ex. 24 | 23.5 | 23 | 25 | 24.5 | 27 | 31 | 33 | 35 | 37 | 38 | 38 | 38.5 | 38 | 38 | 37 | 35 | 32.5 | 30.5 | 29.5 |
| Ex. 25 | 22 | 21.5 | 23 | 22 | 23 | 25 | 26 | 28 | 29 | 29.5 | 29.5 | 29.5 | 29.5 | 29 | 28.5 | 28 | 27 | 26 | 25.5 |

### Test Example 7

### Storage Stability Test (Accelerated Test)

### (1) Test Method

30 g/Aluminum Laminated Film Package

30 g of a composition containing SDIC and OX (Comparative Example 13) and 30 g of a composition containing HOC1 and OX (Example 26), each having the formulation shown in Table 13, were prepared, and they were each packaged in aluminum laminated film bags sealed on three sides, hermetically sealed by heat sealing, and stored under accelerated conditions (40° C./75% RH and 50° C./30% RH).

460 g/Aluminum Pouch Package

460 g of a composition containing SDIC and OX (Comparative Example 14) and 460 g of a composition containing HOC1 and OX (Example 27), each having the formulation shown in Table 13, were prepared, and they were each packaged in aluminum pouch bags, hermetically sealed by heat sealing, and stored under accelerated conditions (40° C./75% RH and 50° C./30% RH).

In the accelerated test, a portion of each composition was removed after 1, 1.5, 2, and 3 months at 40° C./75% RH, and after 1 and 2 months at 50° C./30% RH, and the effective chlorine content (in terms of Cl₂), the pH of a 1% aqueous solution, the volume change rate of the aluminum laminated film package or aluminum pouch package (presence of swelling), and changes in the appearance of the aluminum pouch package were measured or confirmed (N=3 for each).

TABLE 13

| Component of | wt % | wt % |
|---|---|---|
| composition | (Comp. Exs. 13 & 14) | (Exs. 26 & 27) |
| SDIC | 45 | — |
| HOC1 | — | 53.3 |
| OX | 54 | 45.8 |
| PDADMAC | 1 | 0.9 |

TABLE 14
30 g/aluminum laminated film package

| | | 40° C./75% RH | | | | 50° C./30% RH | |
|---|---|---|---|---|---|---|---|
| | | 1 | 2 | 3 | 6 | 1 | 2 |
| | Initial | month | months | months | months | month | months |
| | value | later | later | later | later | later | later |
| Comp. Ex. 13 | | | | | | | |
| Total oxidizing agent | 100.0 | 100.0 | 97.0 | 99.3 | 97.8 | 100.0 | 98.6 |
| content retention (%) | | | | | | | |
| pH (1% aq. sol.) | 4.03 | 3.91 | 3.73 | 3.86 | 3.90 | 3.93 | 3.79 |
| Volume change rate (%) | 100 | 102 | 109 | 111 | 165 | 118 | 138 |
| State of aluminum | — | No | No | No | Corroded | No | No |
| laminated film package | | change | change | change | | change | change |
| Ex. 26 | | | | | | | |
| Total oxidizing agent | 100.0 | 99.5 | 98.8 | 98.3 | 98.0 | 100.0 | 98.5 |
| content retention (%) | | | | | | | |
| pH (1% aq. sol.) | 4.61 | 4.23 | 4.22 | 4.26 | 4.20 | 4.42 | 4.28 |
| Volume change rate (%) | 100 | 100 | 102 | 100 | 106 | 106 | 107 |
| State of aluminum | — | No | No | No | No | No | No |
| laminated film package | | change | change | change | change | change | change |

TABLE 15
460 g/aluminum pouch package

| | Initial | 40° C./75% RH | 40° C./75% RH | 50° C./30% RH |
|---|---|---|---|---|
| | value | 1.5 months later | 3 months later | 2 months later |
| Comp. Ex. 14 | | | | |
| Total oxidizing agent | 100.0 | 99.9 | — | 97.8 |
| content retention (%) | | | | |
| pH (1% aq. sol.) | 4.03 | 3.91 | — | 3.79 |
| Volume change rate | 100 | — (unmeasurable | — | — (unmeasurable |
| (%) | | due to corrosion) | | due to corrosion) |
| State of aluminum | — | Significant corrosion | — | Corrosion observed |
| pouch package | | observed (FIG. 4) | | (FIG. 5) |
| Ex. 27 | | | | |
| Total oxidizing agent | 100.0 | — | 90.8 | 89.7 |
| content retention (%) | | | | |
| pH (1% aq. sol.) | 4.61 | — | 4.29 | 4.27 |
| Volume change rate | 100 | — | 103 | 106 |
| (%) | | | | |
| State of aluminum | — | No corrosion | No corrosion | No corrosion |
| pouch package | | observed | observed | observed |

*Comp. Ex. 11 was severely corroded, and the test was ended after 1.5 months.

### (2) Results and Discussion

From Table 14, in the test of 30 g/aluminum laminated film package, Comparative Example 13 and Example 26 both maintained a high total oxidizing agent content retention of about 900 or more compared to the initial value after 3 months of storage at 40° C./75% RH and after 2 months of storage at 50° C./30% RH.

Both Comparative Example 13 and Example 26 showed a slight tendency for pH (1% aqueous solution) to decrease from the initial value after 3 months of storage at 40° C./75% RH and after 2 months of storage at 50° C./30% RH. However, no significant difference in tendency was observed between the Comparative Example and the Example.

On the other hand, when comparing Comparative Example 13 and Example 26 under the same conditions and storage periods, in both 40° C./75% RH and 50° C./30% RH conditions, Example 26 showed considerably less volume increase (swelling) of the aluminum laminated film package compared to Comparative Example 13.

This suggests that in Comparative Example 13, OX and SDIC reacted in some way during the accelerated test, resulting in gas generation. On the other hand, in Example 26, in which HOC1 was used in place of SDIC, almost no swelling of the aluminum laminated film package occurred under either of the accelerated conditions. From this, the use of HOC1 is considered to inhibit the reaction of the oxygen-based oxidizing agent OX and the chlorine-based oxidizing agent SDIC in a stored state even under the accelerated conditions.

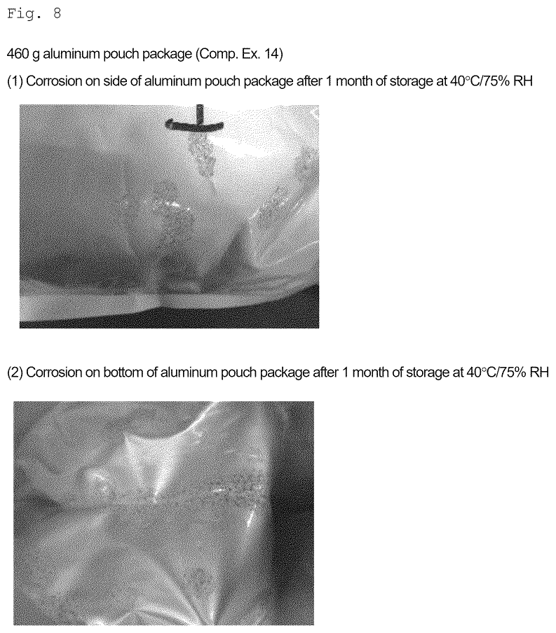

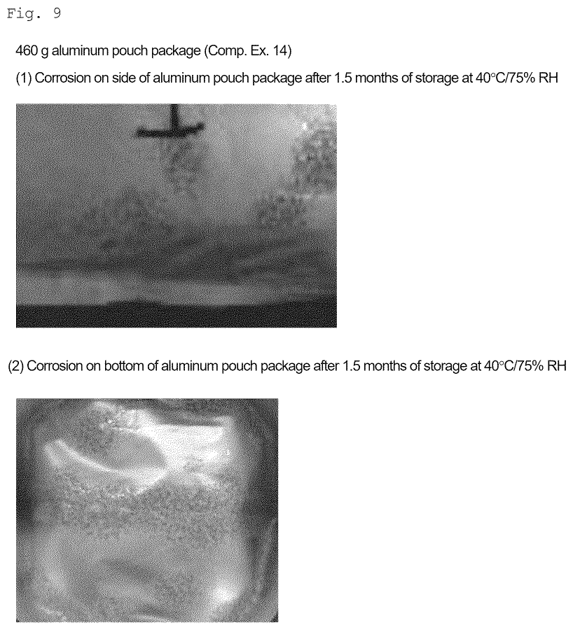

From Table 15, in the test of 460 g/aluminum pouch package, in Comparative Example 14, aluminum corrosion was observed on the side and bottom of the aluminum pouch package under the storage conditions of 40° C./75% RH after 1 month of storage (see FIG. 8). Therefore, the volume could not be measured. After 1.5 months of storage, the corrosion of the aluminum pouch package progressed further (see FIG. 9); thus, the test was discontinued.

In Example 27, even after 3 months of storage at 40° C./75% RH, no aluminum corrosion was observed in the aluminum pouch package, and the volume change rate was only 103%.

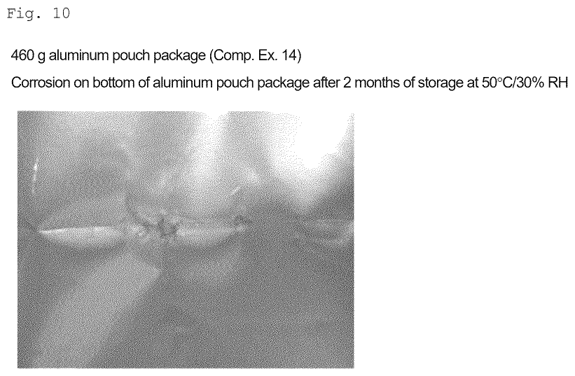

In Comparative Example 14, after 2 months of storage at 50° C./30% RH, aluminum corrosion was observed on the bottom of the aluminum pouch package (see FIG. 10). Therefore, the volume could not be measured.

In Example 27, even after 2 months of storage at 50° C./30% RH, no aluminum corrosion was observed in the aluminum pouch package, and the volume change rate was only 106%.

### Test Example 8

### Aqueous Solution Stability Test

### (1) Test Method

1.198 g of the composition of Comparative Example 13 and 1.427 g of the composition of Example 26 were each added and dissolved in 1 L of distilled water at 25° C. to prepare aqueous solutions. Immediately after preparation, the aqueous solutions were stored statically at the same temperature. After 1, 3, 5, 8, and 24 hours, each aqueous solution was collected from the aqueous solution with a 100 mL whole pipette, and the pH and effective chlorine content of the aqueous solution were measured and recorded. The results are shown in Table 16.

### (2) Results and Discussion

From Table 16, there was no significant difference between Comparative Example 13 and Example 26 in terms of the effective chlorine content retention and change in pH in the aqueous solution state. This confirmed that the combination of HOC1 and OX was as effective in removing water turbidity and algae growth as the combination of SDIC and OX. That is, it is expected to be also effective as an oxidizing agent when a halogen-based oxidizing agent having a coating layer is used in place of a conventional chlorine-based oxidizing agent.

TABLE 16

| | | Time elapsed after preparation | | | | | |
|---|---|---|---|---|---|---|---|
| | | of aqueous solution (h) | | | | | |
| | Test items | 0 | 1 | 3 | 5 | 8 | 24 |
| Comp. | Total oxidizing agent | 100.0 | 100.0 | 98.4 | 95.9 | 91.7 | 74.4 |
| Ex. 13 | content retention (%) | | | | | | |
| | pH | 4.33 | 4.33 | 4.33 | 4.32 | 4.28 | 4.28 |
| Ex. 26 | Total oxidizing agent | 100.0 | 100.0 | 99.6 | 92.0 | 91.2 | 81.2 |
| | content retention (%) | | | | | | |
| | pH | 4.63 | 4.65 | 4.64 | 4.62 | 4.58 | 4.48 |

### INDUSTRIAL APPLICABILITY

The present invention is industrially applicable because it can provide a composition that has high water treatment and bleaching effects, that inhibits heat generation when water is added to the composition, that inhibits the swelling and breakage of a packaging container during storage, and that further has excellent storage stability.

1. A solid composition comprising a halogen-based oxidizing agent and an oxygen-based oxidizing agent, wherein the halogen-based oxidizing agent or the oxygen-based oxidizing agent, or both, are covered with a coating layer.

2. The composition according to claim 1, which is one composition selected from the group consisting of (1) to (3) below:
(1) a composition comprising
a halogen-based-oxidizing-agent-containing material that contains a halogen-based oxidizing agent and a coating layer on its surface, and
an oxygen-based oxidizing agent,
(2) a composition comprising
an oxygen-based-oxidizing-agent-containing material that contains an oxygen-based oxidizing agent and a coating layer on its surface, and
a halogen-based oxidizing agent, and
(3) a composition comprising
a halogen-based-oxidizing-agent-containing material that contains a halogen-based oxidizing agent and a coating layer on its surface, and
an oxygen-based-oxidizing-agent-containing material that contains an oxygen-based oxidizing agent and a coating layer on its surface.

3. The composition according to claim 1, wherein the coating layer contains at least one member selected from the group consisting of metal salts of carboxylic acids, surfactants, polysaccharides, higher fatty acids, paraffin waxes, zeolites, and resins.

4. The composition according to claim 3, wherein the coating layer contains a metal salt of a carboxylic acid, and the metal salt of a carboxylic acid is at least one member selected from the group consisting of alkali metal salts of aromatic carboxylic acids, alkali metal salts of acyclic dicarboxylic acids, alkali metal salts of acyclic monocarboxylic acids, and mixtures thereof.

5. The composition according to claim 2, wherein the composition further comprises a coagulant.

6. The composition according to claim 2, wherein the composition is the composition (1).

7. The composition according to claim 6, wherein the content of the halogen-based-oxidizing-agent-containing material in the composition is 5 wt % or more and 95 wt % or less.

8. The composition according to claim 6, wherein the content of the halogen-based oxidizing agent in the halogen-based-oxidizing-agent-containing material is 30 wt % or more and 95 wt % or less.

9. The composition according to claim 6, wherein the content of the oxygen-based oxidizing agent in the composition is 5 wt % or more and 95 wt % or less.

10. A method for producing the composition according to claim 6, comprising mixing a halogen-based-oxidizing-agent-containing material that contains a halogen-based oxidizing agent and a coating layer on its surface with an oxygen-based oxidizing agent.

11. The production method according to claim 10, comprising bringing a coating liquid into contact with a surface of the halogen-based oxidizing agent to produce the halogen-based-oxidizing-agent-containing material.

12. The composition according to claim 2, wherein the composition is the composition (3).

13. A method for producing the composition according to claim 12, comprising mixing a halogen-based-oxidizing-agent-containing material that contains a halogen-based oxidizing agent and a coating layer on its surface with an oxygen-based-oxidizing-agent-containing material that contains an oxygen-based oxidizing agent and a coating layer on its surface.

14. A method for treating a water area, comprising applying the composition according to claim 1 to the water area.

15. A method for treating pulp, comprising bringing the composition according to claim 1 into contact with the pulp.

16. The composition according to claim 2, wherein the coating layer contains at least one member selected from the group consisting of metal salts of carboxylic acids, surfactants, polysaccharides, higher fatty acids, paraffin waxes, zeolites, and resins.

17. The composition according to claim 16, wherein the coating layer contains a metal salt of a carboxylic acid, and the metal salt of a carboxylic acid is at least one member selected from the group consisting of alkali metal salts of aromatic carboxylic acids, alkali metal salts of acyclic dicarboxylic acids, alkali metal salts of acyclic monocarboxylic acids, and mixtures thereof.
